(19) United States
(12) Patent Application Publication
(10) Pub. No.: US 2010/0254061 A1
(43) Pub. Date: Oct. 7, 2010

(54) SURGE ABSORBER WITH SIDE GAP ELECTRODE AND METHOD OF MANUFACTURING THE SAME

(76) Inventors: Jaesu Ryu, Seoul (KR); Taesung Kim, Gyeonggi-do (KR); Hyuntae Joo, Incheon (KR); Hungrok Lee, Incheon (KR); Jaewook Lee, Incheon (KR); Yoonho Hwang, Seoul (KR); Kyungpyo Hong, Gyeonggi-do (KR)

Correspondence Address: DICKSTEIN SHAPIRO LLP, 1825 EYE STREET NW, Washington, DC, 20006-5403, US

(21) Appl. No.: 12/675,721

(22) PCT Filed: Aug. 27, 2008
(86) PCT No.: PCT/KR08/05014

§ 371 Date: Feb. 26, 2010

(30) Foreign Application Priority Data
Aug. 27, 2007 (KR) 10-2007-0085920
Jan. 22, 2008 (KR) 10-2008-0006801
Jul. 1, 2008 (KR) 10-2008-0063438

(51) Int. Cl. H02H 9/06

(52) U.S. Cl. 361/118

(57) ABSTRACT

Disclosed is a surge absorber with a side gap electrode and a method of manufacturing the same capable of easily implementing a uniform gap to a thickness of a sheet and making operating characteristics better by forming a gap electrode at a side surface. The surge absorber includes: an element on which a plurality of sheets are stacked; a first electrode pattern having a first gap electrode unit that is formed on the sheet inside the element and is exposed to the outside of the element; and a second electrode pattern having a second gap electrode unit that is formed on the sheet inside the element and is exposed to the outside of the element, the first and second gap electrode units forming a gap to a thickness of the sheet interposed therebetween.

### TECHNICAL FIELD

The present invention relates to a surge absorber with a side gap electrode and a method of manufacturing the same, and more particularly, to a surge absorber with a gap electrode that can be controlled to a thickness of a side sheet so as to block surge components and a method of manufacturing the same.

### BACKGROUND ART

Generally, a surge absorber (referred to as a suppressor) disposes a predetermined empty space (discharge space) between two edges of confronted electrode to block surge voltage or surge current having relatively small energy and to bypass surge voltage or surge current having relatively large energy.

FIG. 1 is a cross-sectional view showing one example of the surge absorber in the related art. The surge absorber in FIG. 1 includes: an element 10; gap electrodes 12a and 12b formed on an upper surface of the element 10; a discharge medium 14 filled in the gap (referred to as discharge space) between the gap electrodes 12a and 12b; and external terminals 16a and 16b that are formed on the element 10 and are connected to one end of the gap electrodes 12a and 12b.

The element 10 is configured of a plurality of ceramic sheets or varistor sheets using alumina as main components, LTCCs, etc. The gap electrodes 12a and 12b are formed over an uppermost ceramic sheet (that is, a case except for a protective layer (not shown)) of the element 10 by a sputtering method, etc. In FIG. 1, the gap electrodes 12a and 12b are formed by a thin film process.

The discharge medium 14 is formed by mixing metal materials, such as Al, Ag, Pt, etc. with an insulator such as Al₂O₃, SiO₂ and epoxy (or silicon). The discharge medium 14 may be filled only in the gap between the gap electrode 12a and the gap electrode 12b and may be filled in the gap between the gap electrode 12a and the gap electrode 12b as well as in the neighborhood of the gap.

FIG. 2 is a cross-sectional view showing another example of the surge absorber in the related art. Most of components shown in FIG. 2 are similar to those shown in FIG. 1, however, the difference is that a discharge medium 24 is Wilt inside an element 20. Reference numerals denoting the components shown in FIG. 2 are different reference numerals of FIG. 1. However, those skilled in the art can easily understand the corresponding components.

In FIG. 2, the discharge medium 24 is filled in a predetermined portion (discharge space) between a gap electrode 22a and a gap electrode 22b oppositely disposed on the upper and the lower.

In FIG. 2, the discharge medium 24 is formed by mixing metal materials, such as Ru, Pt, etc., with insulator of Al₂O₃, SiO₂ and glass.

The problems of the surge absorber in the related art are as follows.

In the case of the surge absorber of FIG. 1, when the element 10 is fired, it contracts to some degree. Therefore, the gap electrodes 12a and 12b should be formed in consideration of the contraction of the element 10 so as to make the gap between the gap electrodes 12a and 12b be predetermined value.

Generally, since the contraction of the element 10 is difficult to accurately consider as well as the contraction of the gap electrodes 12a and 12b should be considered, even although a thin film printing device is used, it is difficult to make the gap between the gap electrodes 12a and 12b to a desired numerical value (for example, approximately 10 μm. Of course, if the performance of the thin film printing device for forming the gap electrode is excellent, the gap is accurately printed such that the gap having a desired numerical value can be obtained. However, purchasing the thin film printing device having excellent performance requires huge cost as well as maintenance cost thereof is huge. Therefore, it is inappropriate to use the thin film printing device having excellent performance.

Since the gap electrodes 12a and 12b and the discharge medium 14 are exposed on an upper surface of the element 10, a process, which further forms a protective layer (a dummy sheet or an over glazing layer) (not shown) for protecting the gap electrodes 12a and 12b and the discharge medium 14, is needed.

Meanwhile, the surge absorber in the related art of FIG. 1 does not simultaneously perform the gap electrodes 12a and 12b and the element 10 and forms the gap electrodes 12a and 12b after performing the burning process on the element 10, such that a cumbersome process, such as a heat treatment process for bonding the element with the gap electrodes, is needed to manufacture the surge absorber.

In the case of a surge absorber of FIG. 2, a simultaneous burning of an element 20 and gap electrodes 22a and 22b is performed structurally. Thereby, the surge absorber of FIG. 2 is simpler in the manufacturing process than the surge absorber of FIG. 1. However, when the element 20 and the gap electrodes 22a and 22b are simultaneously fired, solvent, or the like, which is included in the discharge medium 24, is vaporized. The vaporized material has a bad effect on the element 20 until it is completely discharged from element 20. For example, a peeling phenomenon (crack, non-adherence, etc.) at an interface between the gap electrodes 22a and 22b and the discharge medium 24 due to the vaporized solvent, etc., occurs. The element 20 is twisted during the simultaneous burning due to the vaporized solvent, etc. Therefore, when the simultaneous burning is performed, the structure of FIG. 2 has weak impact resistance as well as degrades the yield of products. Further, the selection of the discharge medium 24 is restricted due to the use of the simultaneous burning method. The structure of FIG. 2 does not have the complete element 20 and the complete gap between the gap electrode 22a and the gap electrode 22b after performing the burning process as well as has the defective discharge medium 24 after performing the burning process.

Therefore, a need exists for the surge absorber that can solve the above-mentioned problems of the surge absorber in the related art of FIGS. 1 and 2.

### DISCLOSURE OF INVENTION

### Technical Problem

The present invention proposes to solve the problems in the related art. It is an object of the present invention to provide a surge absorber with a side gap electrode and a method of manufacturing the same so as to easily form a uniform gap and have good operating characteristics by forming the side gap electrode.

### Technical Solution

In order to achieve the above-mentioned object, there is provided a surge absorber with a side gap electrode according to an exemplary embodiment of the present invention including: an element on which a plurality of sheets are stacked; a first electrode pattern having a first gap electrode unit that is formed on the sheet inside the element and is exposed to the outside of the element; and a second electrode pattern having a second gap electrode unit that is formed on the sheet inside the element and is exposed to the outside of the element, the first and second gap electrode units forming a gap to a thickness of the sheet interposed therebetween.

The surge absorber further includes a first external terminal and a second external terminal formed on the element. The first electrode pattern further includes a first internal electrode unit connected to the first external terminal and the second electrode pattern further includes a second internal electrode unit connected to the second external terminal.

The first electrode unit and the second electrode unit are exposed to the same side surface of the electrode.

The exposed first gap electrode unit and the second gap electrode unit are covered by the discharge medium.

A concave part is formed at the side surface of the element and the first and second gap electrode units are exposed through the concave part. In this case, the discharge medium is filled in the concave part. An outer surface of the filled discharge medium does not project from the side surface of the element.

The element is formed with holes and the first and second gap electrode units are exposed to an inner side surface of the hole. In this case, the hole is formed to be penetrated through the element.

The first electrode pattern further includes a third gap electrode unit that is branched from a part of the corresponding electrode pattern and is exposed to the outside of the element and the second electrode pattern further includes a fourth gap electrode unit that is branched from a part of the corresponding electrode pattern and is exposed to the outside of the element, wherein the third gap electrode unit and the fourth gap electrode unit may form a gap to a thickness of the sheet interposed therebetween. In this case, the first gap electrode unit and the second gap electrode unit are exposed to a first side surface of the element and the third gap electrode unit and the fourth gap electrode unit are exposed to a second side surface of the element. The exposed first gap electrode unit and the exposed second gap electrode unit are covered by the discharge medium and the exposed third gap electrode and the exposed fourth gap electrode are covered by the discharge medium. Each of the first and second sides of the element is formed with the concave parts and the first gap electrode unit and the second gap electrode unit are exposed through the concave parts of the first side and the third gap electrode unit and the fourth gap electrode are exposed through the concave part of the second side. Each concave part is filled with the discharge medium.

Each of the first electrode pattern and the second electrode pattern is formed in plural and the first gap electrode unit in each first electrode pattern and the second gap electrode unit in each second electrode pattern forms the gap to the thickness of the sheet interposed therebetween. In this case, a plurality of first external terminals formed on one surface of the element and a plurality of second external terminals formed on the other surface of the element are further provided and each of the plurality of first electrode patterns includes the first internal electrode units connected to the plurality of first external terminals and each of the plurality of second electrode patterns includes the second internal electrode units connected to the plurality of second external terminals. The plurality of first gap electrode units and the plurality of second gap electrode units are exposed to a surface on which the plurality of first external terminals and the plurality of second external terminals are not formed.

The holes are formed in the element and the first gap electrode unit is exposed to an inner side surface of the hole and the second gap electrode unit is disposed on a bottom surface of the hole.

There is provided a surge absorber with a side gap electrode according to another embodiment of the present invention including: an element on which a plurality of sheets are stacked; a first input external terminal formed in the element; a first output external terminal formed in the element; a ground external terminal formed in the element; a first internal electrode pattern having a first gap electrode unit that is formed on the sheet inside the element and is connected to the first input external terminal and the first output external terminal hit is exposed to the outside of the element; and an internal ground pattern having a first ground gap electrode unit that is formed on the sheet inside the element and is connected to a ground external terminal but is exposed to the outside of the element, the first gap electrode unit and the first gap electrode unit forming a gap to a thickness of the sheet interposed therebetween.

The surge absorber further includes: a second input external terminal formed in the element; a second output external terminal formed in the element; and a second internal electrode pattern that is formed to be spaced from the first gap electrode unit on the sheet inside the element and is connected to the second input external terminal and the second output external terminal but includes the second gap electrode unit exposed to the outside of the element. The internal ground pattern further includes a second ground gap electrode unit exposed to the outside of the element and the second gap electrode unit and the second ground gap electrode forms the gap to the thickness of the sheet interposed therebetween. In this case, the first input external terminal and the second input external terminal are formed on a first side surface of the element and the first output external terminal and the second output external terminal are formed on a second side surface of the element. The ground external terminal is formed on one side and both sides between the first input terminal and the second input external terminal and between the first output external terminal and the second output external terminal. The ground external terminal is formed at a side different from the first side and the second side.

There is provided a method of manufacturing a surge absorber with a side gap electrode according to yet another embodiment of the present invention including: forming a first electrode pattern that forms a first electrode pattern on a first sheet having a plurality of unit device regions; forming a second electrode pattern that forms a second electrode pattern on a second sheet having a plurality of unit device regions; forming a stacking body that stacks a plurality of sheets including the first sheet and the second sheet hit overlappedly stacks a part of the first electrode pattern and a part of the second electrode pattern; forming a plurality of holes at a portion where a part of the first electrode pattern and a part of the second electrode pattern are overlapped with each other so that a part of the first electrode pattern and a part of the second electrode pattern are exposed to an inner side surface of the holes and forms a gap to a thickness of the sheet interposed therebetween; and forming a plurality of unit elements by cutting the stacking body for each unit element region so that each of the plurality of holes is separated by the cutting.

The method further includes filling the plurality of holes formed by the forming the holes with the discharge medium before the cutting. In contrast, the method further includes filling a part of each of the plurality of separated holes with the discharge medium after the cutting.

### ADVANTAGEOUS EFFECTS

With the present invention having the above-mentioned configuration, the gap between the gap electrode units is controlled to the thickness of the sheet interposed between the gap electrode units overlapped up and down, such that the uniform gap can easily be achieved as compared to the related art (FIG. 1).

The gap electrode units are formed on one surface of the plurality of sheets but are exposed to be overlapped with at least one outer surface of the plurality of sheets, such that a problem, such as the deterioration of the element, etc. does not occur when simultaneously burning the gap electrode unit and the element. In other words, the gap electrode unit is exposed to the side surface of the element, such that the deterioration of the element due to the vaporization of components from the discharge medium when simultaneously burning the gap electrode unit and the element can be solved, thereby making the operation characteristics good.

Even when the gap electrode unit and the element are simultaneously fired, the discharge medium is formed to cover the gap electrode unit exposed to the side surface of the element, thereby broadening a range of material selection for the discharge medium.

After the simultaneous burning of the gap electrode unit and the element, the discharge medium is hardened, such that the deterioration of the element due to the vaporization of components from the discharge medium is solved as compared to the related art (FIG. 2).

Since the plurality of discharge units for discharging the gap are formed at the side surfaces of the element, even though the discharge units at any one side surface of the element are damaged, the discharge units on the other side surface thereof can normally be operated. In particular, the concave part is formed at the side surface of the element and is filled to prevent the discharge medium from projecting, thereby preventing the discharge medium from damaging and disrupting.

The concave part is filled so as to prevent the discharge medium from projecting, such that the effective size and installation can be achieved. Since the discharge medium does not project from the side surface of the element, the entire size becomes smaller and the occupied area in the installation region becomes smaller, as compared to the case where the discharge medium is projected.

The surge absorber can be applied as a surge absorber arrayed into the plurality of channels, such as two channels, four channels, etc.

In the case of the array-type surge absorber of the plurality of channels, since the side surface to which the gap electrode unit is exposed and the side surface at which the internal electrode unit is formed are different side surfaces, it is possible to provide the array-type surge absorber of the plurality of channels using an extra space of the element as much as possible.

The array-type surge absorber of the plurality of channels that minimizes the number of sheets required for manufacturing can be implemented.

The array-type surge absorber of the plurality of three-terminal channels having low capacitance can be implemented, such that the delay and distortion of signals are removed in a high-speed line.

The array-type surge absorber of the plurality of three-terminal channels for each channel can provide stability of operation and easiness of wirings on a PCB, as compared to the array-type surge absorber of two channels and four channels having two terminals for each channel, etc.

### BRIEF DESCRIPTION OF THE DRAWINGS

FIG. 1 is a view for explaining one example of a surge absorber in the related art;

FIG. 2 is a view for explaining another example of a surge absorber in the related art;

FIG. 3 is a front view of a surge absorber according to a first embodiment of the present invention;

FIG. 4 is a view for explaining a configuration and manufacturing process of the surge absorber of FIG. 3;

FIG. 5 is a view for explaining a modified example of a gap electrode shown in FIG. 4;

FIG. 6 is a view showing a modified example of a discharge medium shown in FIG. 4;

FIG. 7 is a view for explaining a configuration of a surge absorber according to a second embodiment of the present invention;

FIG. 8 is a front view of the surge absorber of FIG. 7;

FIG. 9 is a view in which sheets formed with a first gap electrode and a second gap electrode shown in FIGS. 7 and 8 are separated;

FIG. 10 is a view for explaining a manufacturing process of the surge absorber according to a second embodiment of the present invention;

FIG. 11 is a view for schematically showing a structure of a surge absorber according to a third embodiment of the present invention;

FIG. 12 is a view for explaining a manufacturing process of the surge absorber of FIG. 11;

FIG. 13 is a view for schematically showing a structure of a surge absorber according to a fourth embodiment of the present invention;

FIG. 14 is a view for explaining a manufacturing process of the surge absorber of FIG. 13;

FIG. 15 is a view for schematically showing a structure of a surge absorber according to a fifth embodiment of the present invention;

FIG. 16 is a view for explaining a manufacturing process of the surge absorber of FIG. 15;

FIG. 17 is a view for schematically showing a structure of a surge absorber according to a sixth embodiment of the present invention;

FIG. 18 is a view for explaining a manufacturing process of the surge absorber of FIG. 17;

FIG. 19 is a view for schematically showing a structure of a surge absorber according to a seventh embodiment of the present invention;

FIG. 20 is a cross-sectional view taken along the line A-A of FIG. 19;

FIG. 21 is a cross-sectional view of a surge absorber according to an eighth embodiment of the present invention; and

FIG. 22 is a view adopted for explaining a manufacturing process of the surge absorber of FIG. 21.

### BEST MODE FOR CARRYING OUT THE INVENTION

Hereinafter, a surge absorber with a side gap electrode and method of manufacturing the same will be described with reference to the accompanying drawings.

### First Embodiment

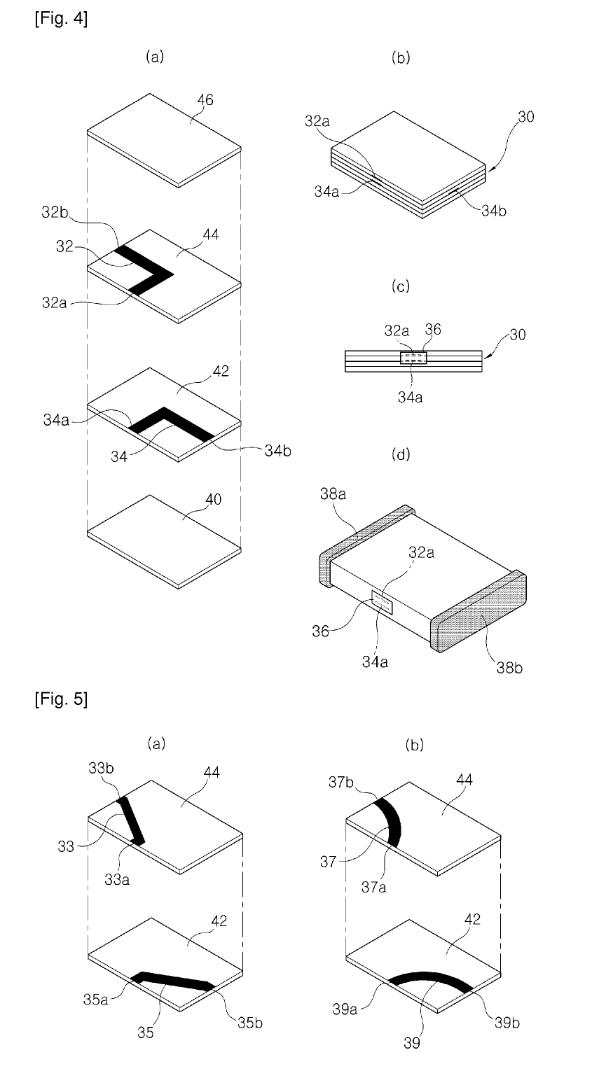

FIG. 3 is a front view of a surge absorber according to a first embodiment of the present invention and FIG. 4 is a view for explaining a configuration and manufacturing process of the surge absorber of FIG. 3.

A surge absorber of a first embodiment includes an element 13, a first electrode pattern 32, a second electrode pattern 34, and a discharge medium 36.

The element 30 is formed by stacking a plurality of sheets 40, 42, 44, and 46. Both outer side surfaces to be opposite to each other of the element 30 are formed with external terminals 38a and 38b.

The first electrode pattern 32 is formed on a sheet 44 inside the element 30 in an L-letter shape that is a capital of English Alphabet. One side end part 32a (first gap electrode unit) of the first electrode pattern 32 is exposed to any one outer side surface (that is, left side surface) of both side surfaces of the element 30. Other side end part 32b (first internal electrode unit) of the first electrode pattern 32 is exposed to an outer side surface different from both outer side surfaces.

The second electrode pattern 34 is formed on the sheet 42 inside the element 30 in a symmetrical shape with the first electrode pattern 32. One side end part 34a (second gap electrode unit) of the second electrode pattern 34 is exposed to the other outer side surface (that is, right side surface) of both outer side surfaces of the element 30. The other side end part 34b (second internal electrode unit) of the second electrode pattern 34 is exposed to one outer side surface different from both outer side surfaces.

The first gap electrode unit 32a and the second gap electrode unit 34a are overlapped with each other, such that they are exposed to the same side surface of the element 30. Thereby, the gap between the first gap electrode unit 32a and the second gap electrode unit 34a, which are exposed to be overlapped with each other, can easily be controlled only to the thickness of the sheet. The discharge medium 36 covers the gap between the first gap electrode unit 32a and the second gap electrode unit 34a using a printing method.

In the first embodiment, the gap discharge is performed the gap between the first gap electrode unit 32a and the second gap electrode unit 34a.

Hereinafter, a manufacturing process of the surge absorber according to the first embodiment of the present invention will be described.

First, slurry is manufactured so as to manufacture the plurality of sheets. For example, additives, such as Bi₂O₃, CoO, MnO, etc., are added to dielectric materials (for example, alumina, borosilicate glass series) having low-k, which is dielectric constant of approximately 10 or less. Thereafter, raw material powders are prepared by performing a ball mill for about 24 hours using a solvent, such as water or alcohol, etc. PVB based binder is measured to about 6 wt % for the raw material powders and is then dissolved in toluene/alcohol based solvent. Thereafter, the dissolved PVB based binder as an additive is input into the prepared raw material powders. Then, the slurry is prepared by milling and mixing the mixture for 24 hours using a small ball mill. The numerical values as indicated above are only one example and can therefore be varied according to the manufacturing environment and when necessary.

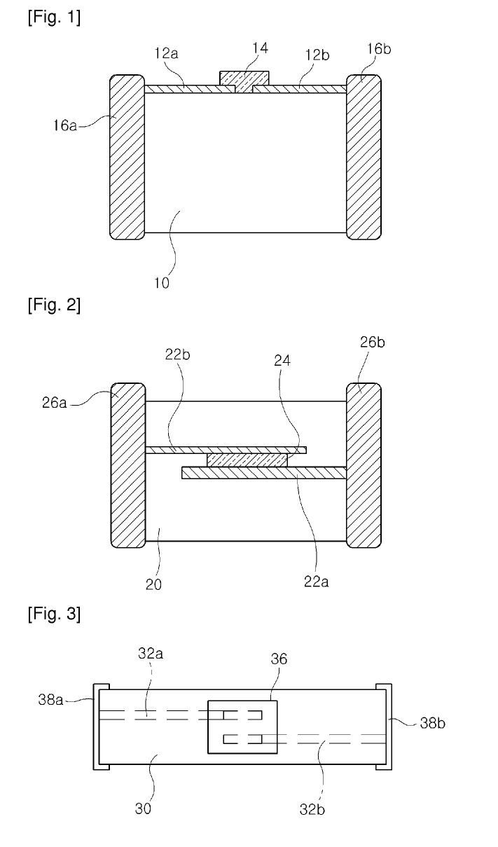

A green sheet having a desired thickness (for example, about 15 μm) is manufactured by processing the slurry using a doctor blade method, etc. The manufactured green sheet is cut at a desired length to manufacture the plurality of sheets 40, 42, 44, and 46. Meanwhile, the reason for making the thickness of the green sheet at about 15 μm is that the contraction in stacking, compressing, and burning processes later should be considered. The thickness of one sheet is approximately 10 μm by subjecting to the stacking, compressing, and burning processes later. Thereby, the gap between the gap electrode units can easily be controlled to about 10 μm as compared to the existing printing method (FIG. 1). In FIG. 4, each of the sheets 40 and 46 may be formed in plural when necessary.

As shown in FIG. 4(A), the first and second electrode patterns 32 and 34 in an L-letter shape, which is a capital of English Alphabet, are printed on the sheets 42 and 44. The first internal electrode unit 32b of the first electrode pattern 32 printed on the sheet 44 is exposed to any one outer side surface (that is, left side surface) of both outer side surfaces of the corresponding sheet 44 and the first internal electrode unit 32b of the first electrode pattern 32 is exposed to one cuter side surface different from both outer side surfaces. The second internal electrode unit 34b of the second electrode pattern 34 printed on the sheet 42 is exposed to any one outer side surface (that is, right side surface) of both cuter side surfaces of the corresponding sheet 42 and the second gap electrode unit 34a of the second electrode pattern 34 is exposed to one outer side surface different from both outer side surfaces. The first and second electrode patterns 32 and 34 are printed by paste using Ag powders.

Thereafter, the sheet 42 is stacked on the sheet 40 that is the lowermost layer and the sheet 44 is then stacked on the sheet 42. The sheet 46 is stacked on the sheet 44 (see FIG. 4(B)). Thereby, the first and second gap electrode units 32a and 34a are exposed to be overlapped with each other to maintain a predetermined gap. A pressure of approximately 500 to 2000 psi is used when performing the stacking. One formed by the stacking is herein expressed as the element, but may be said to be the stacking body. Thereafter, the element 30 is compressed. A pressure of approximately 500 to 3000 psi is used when performing the compression.

After the stacking and compression is completed, degreasing and burning processes are performed. After the degreasing process is performed at approximately 300° C., the burning process is performed at approximately 800 to 900° C.

The gap between the first gap electrode unit 32a and the second gap electrode unit 34a has a desired numerical value (approximately 10 μm) by subjecting to the stacking, compressing, burning processes in sequence. In other words, the gap between the first and second gap electrode units 32a and 34a is controlled to the thickness of the sheet, such that the desired gap can be implemented much easier than the existing printing method.

In order to print the discharge medium 36, the element 30 is rotated at

90° so that the side surface to which the first and second gap electrode units 32a and 34a are exposed to be overlapped with each other faces upward. The discharge medium 36 for the upwardly exposed gap electrode units 32a and 34a is printed (see FIG. 4(C)). The discharge medium 36 uses metal materials, such as Al, Ag, Pt, Ru, Cu, W, etc., and insulating materials (for example, Al₂O₃, SiO₂) as main raw materials and epoxy, silicon, glass, etc., as binders. The main raw materials and binders are mixed. The discharge medium 36 may be air or polymer. Of course, in addition to the metal materials described above, any metal materials, which can contribute to easily generate the discharge between the gap electrode units 32a and 34a as well as to absorb surge, may be used as the metal materials of the discharge medium 36.

In order to bond the printed discharge medium 36 to the element 30, the discharge medium is hardened at a predetermined temperature. In the first embodiment of the present invention, even though the simultaneous burning of the gap electrode units 32a and 34b and the element 30 is performed, the hardening of the discharge medium 36 is performed later, such that the deterioration problem of the element 30 due to vaporization components in the discharge medium using the existing simultaneous burning method (FIG. 2) can be solved.

Then, the external terminals 38a and 38b to be connected to the first internal electrode unit 32b and the second internal electrode unit 34b are formed at both outer side surface part of the element 30 using a general termination system (see FIG. 4(D)). The external terminal 38a is connected to the first internal electrode unit 32b of the first electrode pattern 32 that is exposed to the corresponding portion. The external terminal 38b is connected to the second internal electrode unit 34b of the second electrode pattern 34 that is exposed to the corresponding portion.

Finally, in order to bond the external terminals 38a and 38b to the element 30, the external terminals 38a and 38b are baked at a predetermined temperature.

Thereby, since the gap between the gap electrode units 32a and 34b is controlled to the thickness of the sheet, the gap can uniformly be implemented as compared to the related art (FIG. 1).

It is possible to perform the simultaneous burning of the gap electrode units 32a and 34a and the element 30.

Even though the simultaneous burning of the gap electrode units 32a and 34a and the element 30 is performed, the discharge medium is formed at the cuter side surface of the element, such that the material selection of the discharge medium does not need to be limited.

After the simultaneous burning of the gap electrode units 32a and 34a and the element 30 is performed, the hardening of the discharge medium 36 is performed, such that the problem of the deterioration of the element due to vaporization components from the discharge medium is solved as compared to the related art (FIG. 2).

In the first embodiment described above, the discharge medium 36 is printed and the external terminals 38a and 38b are then formed. This corresponds to a case where the hardening temperature of the discharge medium is higher than the baking temperature of the external terminal. When the baking temperature of the external terminal is higher than the hardening temperature of the discharge medium, it is preferred to form the external terminal followed by the discharge medium. For example, in the case where the discharge medium is printed and the external terminal is then baked, when the baking temperature of the external terminal is higher than the hardening temperature of the discharge medium, the physical properties of the hardened discharge medium are changed. As in the example described above, when the baking temperature of the external terminal is higher than the hardening temperature of the discharge medium, it is preferred that the external terminal is first formed. In other embodiment to be described below, the discharge medium is printed and the external terminal is then formed, the foregoing description is applied to other embodiments as it is.

In the first embodiment as described above, the first and second electrode pattern are formed in an L-letter shape, but may be changed as shown in FIGS. 5(A) and (B).

In FIG. 5(A), the first and second electrode patterns 33 and 35 are obliquely formed. An exposed one side end part 33a of the first electrode pattern 33 is the first gap electrode unit and the other side end part 35a of the first electrode pattern 33 is the first internal electrode unit. An exposed one side end part 33a of the first electrode pattern 33 is the first gap electrode unit and the other side end part 33b of the first electrode pattern 33 is the first internal electrode unit. An exposed one side end part 35a of the second electrode pattern 35 is the second gap electrode unit and the other side end part 35b of the second electrode pattern 35 is the second internal electrode unit.

In FIG. 5(B), first and second electrode patterns 37 and 39 are is obliquely formed to be rounded. An exposed one side end part 37a of the first electrode pattern 37 is the first gap electrode unit and the other side end part 37b of the first electrode pattern 37 is the first internal electrode unit. An exposed one side end part 39a of the second electrode pattern 39 is the second gap electrode unit and the other side end part 39b of the second electrode pattern 39 is the second internal electrode unit.

Generally, the larger the area overlapped between the first gap electrode unit and the second gap electrode unit, the more the capacitance in the overlapped area increases. Since the capacitance in the overlapped area is an undesired component, it is preferred to make the overlapped area as small as possible. In other words, the surge absorber is adopted in a high-speed signal line. When the capacitance in the area overlapped between the gap electrode units is increased, the occurrence possibility of delay and distortion of a signal, etc., becomes high. As a result, it is preferred to make the overlapped area as small as possible.

Therefore, FIG. 5(A) or 5(B) makes the area overlapped between the first and second gap electrode units smaller as compared to FIG. 4, such that it is advantageous in the high-speed signal line as compared to the shape of the gap electrode unit of FIG. 4. However, since there is a slight overlapped area even in the case of FIG. 5(A) or 5(B), it is preferred to manufacture forming sheets 42 and 44 using dielectric materials having low-k (for example, dielectric constant of approximately 10 or less).

Of course, when the first and second gap electrode units are overlapped with each other so that they can be exposed to one outer side surface of the element 30, shapes different from the shapes of FIGS. 4 and 5 may be permitted.

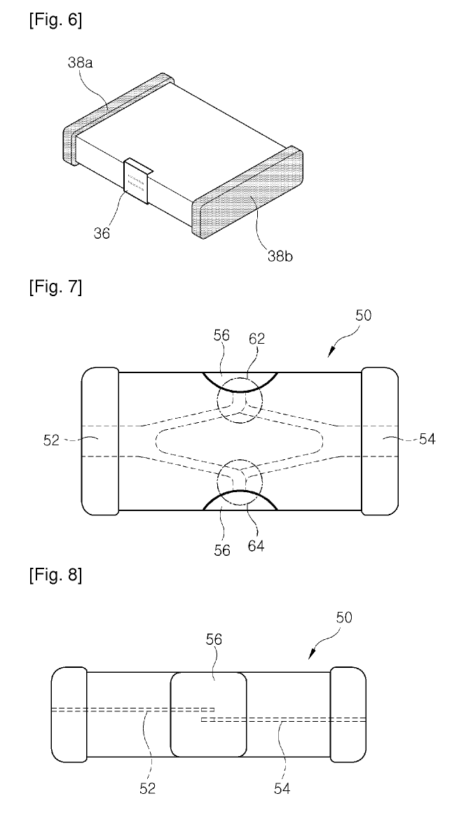

FIG. 6 is a view showing a modified example of the discharge medium 36 shown in FIG. 4. In FIG. 4, the discharge medium 36 is formed by the printing method, but it may be formed by the general termination method as shown in FIG. 6.

Meanwhile, when the discharge medium 36 is projected from one side surface of the element 30 as in the first embodiment, products may be damaged during the handling and storage of products, such that the discharge medium 36 and the parts closely adhered to the discharge medium 36, etc., may be separated. Therefore, although not shown in the drawings, a concave part is formed on the corresponding side surface of the element so that the discharge medium is filled in the concave part. Thereby, the discharge medium does not project such that it can be protected from being damaged and broken. When the discharge medium 36 does not project from the side surface of the element 30, the entire size becomes smaller and the occupied area in the installation region becomes smaller, as compared to the case where the discharge medium is projected. The description of the concave part will be understood from a second embodiment to be described. The surge absorbers in various shapes, which can fill the discharge medium, should be construed to be included within the scope of the present invention.

### Second Embodiment

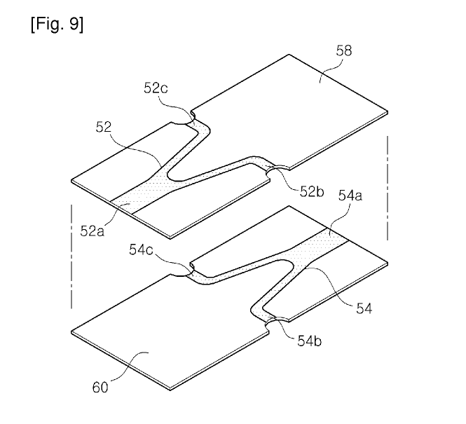

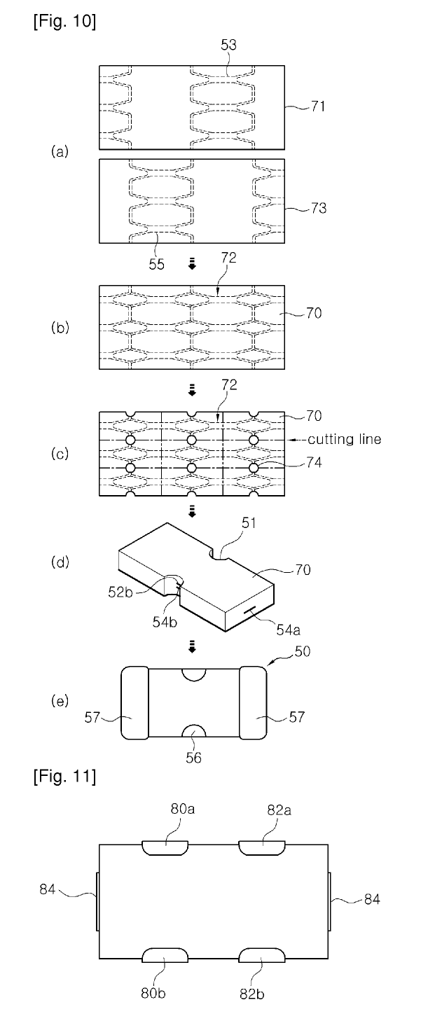

FIG. 7 is a view for explaining a configuration of a surge absorber according to a second embodiment of the present invention, FIG. 8 is a front view of the surge absorber of FIG. 7, FIG. 9 is a view in which sheets formed with a first gap electrode and a second gap electrode shown in FIGS. 7 and 8 are separated, and FIG. 10 is a view for explaining a manufacturing process of the surge absorber according to a second embodiment of the present invention.

A surge absorber 50 of a second embodiment includes a first electrode pattern 52 and a second electrode pattern 54 that are formed to be spaced from each other inside an element 70 and discharge mediums 56 that are filled in concave parts 51 of both outer side surfaces of the element 70.

Preferably, the element 70 is formed of a plurality of sheets, which are stacked. The first electrode pattern 52 is formed on a sheet 58 and the second electrode pattern 54 is formed on a sheet 60. In the drawing, external terminals 57 are formed at a left outer side surface and a right cuter side surface of the element 70.

The first electrode pattern 52 is formed in a Y-letter shape, which is a capital of English Alphabet. The first electrode pattern 52 includes a first internal electrode unit 52a, a first gap electrode unit 52b, and a third gap electrode unit 52c. The first internal electrode unit 52a is exposed to the left cuter side surface of the sheet 58 so that it is connected to the external terminal 57 of the corresponding part. The first gap electrode unit 52b and the third gap electrode unit 52c are extended in a direction facing each other at a region in which the first internal electrode unit 52a is positioned and are branched. The first gap electrode unit 52b and the third gap electrode unit 52c are branched to be exposed in a direction facing each other on the sheet 58. The first gap electrode unit 52b and the third gap electrode unit 52c are formed at a position facing each other in a direction intersecting to a central line (not shown) that crosses the left outer side surface and the right cuter side surface of the sheet 58.

The second electrode pattern 54 is formed in a Y-letter shape, which is a capital of English Alphabet.

The first electrode pattern 54 includes a second internal electrode unit 54a, a second gap electrode unit 54b, and a fourth gap electrode unit 54c. The second internal electrode unit 54a is exposed to the right outer side surface of the sheet 60 so that it is connected to the external terminal 57 of the corresponding part. The second gap electrode unit 54b and the fourth gap electrode unit 54c are extended in a direction facing each other at a region in which the second internal electrode unit 54a is positioned and are branched. The second gap electrode unit 54b and the fourth gap electrode unit 54c are branched to be exposed in a direction facing each other on the sheet 60. The second gap electrode unit 54b and the fourth gap electrode unit 54c are formed at a position facing each other in a direction intersecting to a central line (not shown) that crosses the left outer side surface and the right outer side surface of the sheet 60.

The first gap electrode unit 52b and the second gap electrode unit 54b are overlapped to be spaced at a predetermined interval up and down and the third gap electrode unit 52c and the fourth gap electrode unit 54c are overlapped to be spaced at a predetermined interval up and down. The gap between the first gap electrode unit 52b and the second gap electrode unit 54b, which are overlapped with each other in a specification below, is called the discharge unit 64 and the gap between the third gap electrode unit 52c and the fourth gap electrode unit 54c, which are overlapped with each other, is called the discharge unit 62.

The discharge units 62 and 64 are covered with the discharge medium 56. It can be considered that the material of the discharge medium 56 is the same as the material of the discharge medium 36 of the first embodiment.

The gap discharge is performed in the discharge units 62 and 64. In other words, in the second embodiment, the gap discharge is performed in the gap between the first gap electrode unit 52b and the second gap electrode unit 54b and in the gap between the third gap electrode unit 52c and the fourth gap electrode unit 54c.

As such, the discharge units 62 and 64 are formed at both outer side surfaces in a length direction of the element 70, such that even though one discharge unit loses its function, the other discharge unit can continuously maintain its function. Therefore, the configuration as described above is very useful. In other words, the second embodiment can maintain the performance of products better than the first embodiment that disposes the discharge unit only at one side.

In the second embodiment, the concave parts 51 are formed at both cuter side surfaces in a length direction of the element 70 and the discharge medium 56 is filled in the concave part 51. The first gap electrode unit 52b and the second gap electrode unit 54b are exposed through any one of two concave parts and the third gap electrode unit 52c and the fourth gap electrode unit 54c are exposed through the other concave part.

Although not shown in the drawings, a structure (see the first embodiment) where the concave parts 51 are not formed at both outer side surfaces in a length direction of the element 70 may be permitted. In this case, the discharge medium 56 is convexly projected at both outer side surfaces in a length direction of the element 70. Even in the above configuration, the discharge units are formed at both outer side surfaces in a length direction of the element 70, such that even though any one discharge unit is broken, the other discharge unit can continuously maintain its function.

However, when the discharge medium 56 is convexly projected at both outer side surfaces in a length direction of the element 70 as described above, products may be damaged during the handling and storage of products, such that the discharge medium 56 and the parts closely adhered to the discharge medium 56, etc., may be separated. Further, the entire size becomes large.

Therefore, it is preferred that the concave parts 51 are formed at both outer side surfaces in a length direction of the element 70 and the discharge mediums 56 are filled in the concave parts. In this case, the discharge medium 56 is not convexly projected, such that it can be protected from being damaged and broken. Since the discharge medium 56 does not project from the side surface of the element 70, the entire size becomes smaller and the occupied area in the installation region becomes smaller, as compared to the case where the discharge medium does project.

The first and second electrode patterns 52 and 54 may be formed in a T-letter shape, which is a capital of English Alphabet, but in the second embodiment, the first and second electrode patterns 52 and 54 are formed in a Y-letter shape, which is a capital of English Alphabet, such that the overlapped area thereof is minimized. Of course, in addition to a Y-letter shape, all the shapes, which can minimize the area overlapped between the gap electrode units positioned up and down, may be permitted. The reason is the same as the first embodiment described above. In other words, when the capacitance in the area overlapped between the gap electrode units configuring the discharge unit is increased, the occurrence possibility of delay and distortion of a signal, etc., becomes high. As a result, it is preferred to make the overlapped area as small as possible.

In FIG. 9, since there is a slight overlapped area between the upper and lower gap electrode units, it is preferred to manufacture the sheets 58 and 60 using dielectric materials having low-k (for example, dielectric constant of approximately 10 or less).

Hereinafter, a process for manufacturing the surge absorber according to the second embodiment of the present invention as described above will be described.

First, slurry is manufactured so as to manufacture the plurality of sheets. The process of manufacturing the slurry is the same as the first embodiment described above and therefore, the description thereof will not be repeated.

A green sheet having a desired thickness (for example, about 15 μm) is manufactured by processing the slurry using a doctor blade method, etc. The manufactured green sheet is cut at a desired length to manufacture a plurality of forming sheets. Subsequently, the plurality of forming sheets on which an aggregate of the first electrode patterns and an aggregate of the second electrode patterns are printed are stacked and sintered. Thereafter, the plurality of forming sheets, which are stacked and sintered, are subjected to a final cutting process, such that a plurality of components are separated into an LED package. The LED package of each of the separated components is called a unit element and a region occupied by each unit element is called a unit element region. Therefore, it is understood that the plurality of unit element regions exist in the forming sheet.

Meanwhile, the reason for making the thickness of the green sheet at about 15 μm is that the contraction in the stacking, compressing, and burning processes later should be considered. The thickness of one sheet is approximately 10 μm by subjecting to the stacking, compressing, and burning processes later. Thereby, the gap (gap between the upper and lower) between the gap electrode units configuring the discharge unit can easily be controlled to about 10 μm as compared to the existing printing method (FIG. 1).

Then, as shown in FIG. 10(A), the aggregate 53 of the first electrode patterns is formed in any one forming sheet (for example, 71) of a plurality of forming sheets and the aggregate 55 of the second electrode patterns is formed in the other forming sheet (for example, 73). The aggregate 53 of the first electrode pattern is collectively called the first electrode pattern formed in each unit element region of the corresponding forming sheet 71 and the aggregate 55 of the second electrode pattern is collectively called the second electrode pattern formed in each unit element region of the corresponding forming sheet 73. The aggregates 53 and 55 of the first and second electrode patterns are printed by paste using Ag powder.

Thereafter, the forming sheet 71 is stacked on the forming sheet 73 that is the lower layer. Of course, more than one dummy sheet may be disposed at a bottom part of the forming sheet 73 and more than one dummy sheet may be stacked on the top part of the forming sheet 71. If the stacking is completed, the element 70 is formed as shown in FIG. 10(B). One formed by the stacking is herein expressed as the element, but may be said to be the stacking body. The aggregate 53 of the first electrode patterns and the aggregate of the second electrode patterns are collectively indicated by reference numeral 72 in FIG. 10(B). A pressure of approximately 500 to 2000 psi is used when performing the stacking. Then, the compression is performed. A pressure of approximately 500 to 3000 psi is used when performing the compression.

Thereafter, a portion of mutually overlapped parts in the aggregate 53 of the first electrode patterns and the aggregate 55 of the second electrode patterns, which are stacked in FIG. 10(c), is punched to form a hole 74. The hole 74 becomes the concave part of the element 70 that is subjected to the cutting process later. Then, as shown in FIG. 10(C), the cutting is performed along a cutting line. Thereby, the plurality of elements 70 are formed as shown in FIG. 10(D). In other words, when the cutting is cut along the cutting line of FIG. 10(C), the element 70 is separated in plural. As shown in FIG. 10(D), the concave parts 51 are formed at both outer side surfaces in a length direction of each of the elements 70 that are separated. Thereby, gap electrode units 52b, 54b; 52c, and 54c of each of the elements 70 are exposed through the concave part 51.

In the case of the element 70 manufactured as above, the thickness of the gap between the upper and lower gap electrode units is easily controlled to a desired numerical value (approximately 10 μm). In other words, the gap between the gap electrode units is controlled to the thickness of the sheet interposed between the gap electrode units overlapped up and down (52b and 54b in FIG. 10(D)), such that the desired gap can be implemented much easier than the existing printing method.

Then, the degreasing and burning processes are performed on the plurality of elements 70 as shown in FIG. 10(D). After the degreasing process is performed at approximately 300° C., the burning process is performed at approximately 800 to 900° C.

As shown in FIG. 10(E), the discharge medium 56 is filled in the concave part 51 of the element 70.

In order to bond the printed discharge medium 56 to the element 70, the discharge medium is hardened at a predetermined temperature. In the second embodiment, even though the simultaneous burning of the gap electrode units 52b, 54b; 52c, 54c and the element 30 is performed, the hardening of the discharge medium 56 is performed later, such that the deterioration problem of the element 70 due to vaporization components in the discharge medium using the existing simultaneous burning method (FIG. 2) can be solved.

Then, the external terminal 57, which is connected to the first internal electrode unit 52a and the second internal electrode unit 54a formed inside the element 70 using a general termination system, is formed at both outer side surface parts of the element 70 as shown in FIG. 10(E). It is obvious to those skilled in the art that the external terminal 57 may be formed in the same method as the first embodiment. Therefore, the description thereof will not be repeated.

Finally, in order to bond the external terminals 57 to the element 70, the external terminal 57 is baked at a predetermined temperature.

Thereby, since the gap between the upper and lower gap electrode units is controlled to the thickness of the forming sheet, the gap can uniformly be implemented as compared to the related art (FIG. 1).

The second embodiment can obtain the same effect as the first embodiment as described above as well as since the discharge units are disposed at both outer side surfaces of the element, the discharge unit of the second embodiment can be used longer than that of the first embodiment. In the second embodiment, the discharge units are not projected from both outer side surfaces of the element, thereby reducing a risk of the breakage. Also, since the discharge medium does not project from both outer side surfaces of the element, the entire size becomes smaller and the occupied area in the installation region becomes smaller, as compared to the case where the discharge medium is projected.

The surge absorber of the first and second embodiments as described above can be applied in an array form. Several applied examples having various array forms will be described below. When the surge absorber of the following embodiment is applied to a circuit having the plurality of channels that transmits data at high speed, it will be operated very efficiently. Meanwhile, the surge absorber, which modifies and changes the surge absorber implemented in the array form of the plurality of channels to be described below, should be construed to be included within the scope of the present invention.

### Third Embodiment

FIG. 11 is a view for schematically showing a structure of a surge absorber according to a third embodiment of the present invention. It is understood that the surge absorber of the third embodiment, which indicates a two-channel array type of a surge absorber, is an expansion of the surge absorber of the first embodiment.

In the surge absorber of FIG. 11, first two external terminals 80a and 82a are formed to be spaced from each other at a first outer side surface. Second two external terminals 80b and 82b are formed to be spaced from each other at a second outer side surface (that is, a surface existing at a position opposite to the first outer side surface in a length direction) in a length direction of the element. A discharge medium 84, which covers the gap between the gap electrode units exposed to the corresponding outer side surface is printed at both outer side surfaces in a width direction in the element.

The two-channel array type of the surge absorber of FIG. 11 generates the gap discharge in the gap electrode units exposed to both outer side surfaces in a width direction of the element.

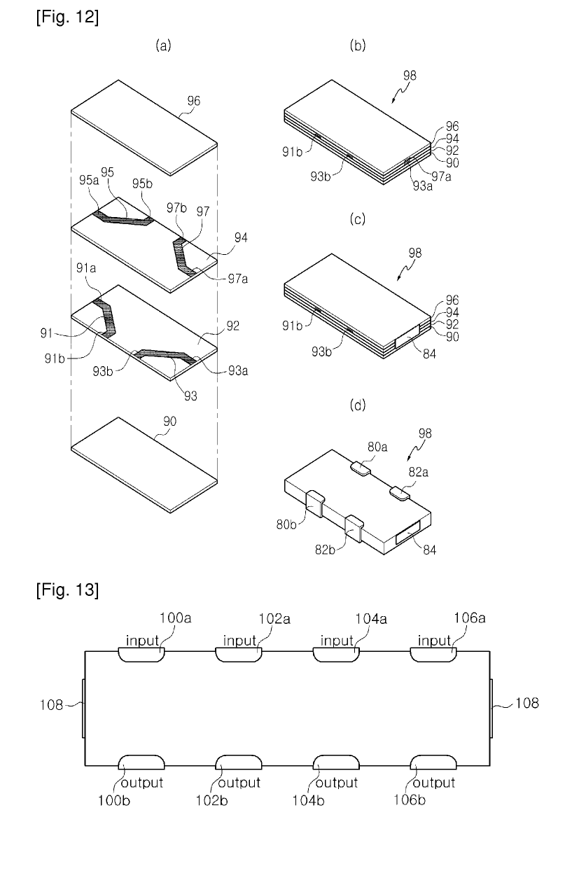

FIG. 12 is a view for explaining a process for manufacturing the surge absorber of FIG. 11. The structure of the surge absorber according to the third embodiment can be better understood through the following description.

First, slurry is manufactured so as to manufacture the plurality of sheets 90, 92, 94, and 96. The process of manufacturing the slurry is the same as the first embodiment described above and therefore, the description thereof will not be repeated.

A green sheet having a desired thickness (for example, about 15 μm) is manufactured by processing the slurry using a doctor blade method, etc. The manufactured green sheet is wt at a desired length to manufacture a plurality of sheets 90, 92, 94, and 96. Meanwhile, the reason for making the thickness of the green sheet at about 15 μm is that the contraction in the stacking, compressing, and burning processes later should be considered. The thickness of one sheet is approximately 10 μm by subjecting to the stacking, compressing, and burning processes later. Thereby, the gap (gap between the upper and lower) between the gap electrode units can easily be controlled to about 10 μm as compared to the existing printing method (FIG. 1).

Thereafter, as shown in FIG. 12(A), a first electrode pattern 95 and a third electrode pattern 97 are formed to be spaced from each other on the sheet 94. A second electrode pattern 91 and a fourth electrode pattern 97 are formed to be spaced from each other on the sheet 92. The first to fourth electrode patterns 95, 91, 97, and 93 are obliquely formed by paste using general Ag powders. The first electrode pattern 95 has a first gap electrode unit 95a and a first internal electrode unit 95b. The second electrode pattern 91 has a second gap electrode unit 91a and a second internal electrode unit 91b. The third electrode pattern 97 has a third gap electrode unit 97a and a third internal electrode unit 97b. The fourth electrode pattern 93 has a fourth gap electrode unit 93a and a fourth internal electrode unit 93b. The first gap electrode unit 95a and the third gap electrode unit 97a on the sheet 94 are exposed to the side surface at a position opposite to each other and the first internal electrode unit 95b and the third internal electrode unit 97b are printed to be exposed to the same side surface. The second gap electrode unit 91a and the fourth gap electrode unit 93a on the sheet 91 are exposed to the side surface at a position opposite to each other and the second internal electrode unit 91b and the fourth internal electrode unit 93b are printed to be exposed to the same side surface.

In FIG. 12(A), the electrode patterns 91, 93, 95, and 97 are obliquely formed. This is to minimize the overlapped area between the gap electrode units overlapped up and down when the sheets 92 and 94 are stacked. In other words, when the overlapped area between the gap electrode units overlapped up and down is minimized, low capacitance can be implemented. As a result, when it is applied to the two-channel high speed line, the delay and distortion of the signal are removed.

In FIG. 12(A), the two electrode patterns are formed on each of two sheets. This is to implement the two-channel array type of the surge absorber that minimizes the number of forming sheets. For example, one electrode pattern may be formed on each of four sheets. Thereby, the surge absorber becomes the array form using the structure of the first embodiment, such that the number of sheets required in the third embodiment is excessive, thereby making the size of the element (stacking body) large. Although the size of the element is somewhat large, it is understood that the structure of the example described above should be construed to be included within the scope of the present invention.

Thereafter, the sheet 92 is stacked on the sheet 90 that is the lowermost layer and the sheet 94 is then stacked on the sheet 92. The sheet 96 is stacked on the sheet 94. The sheet 96 serves as the protective sheet. By such stacking, the element 98 such as FIG. 12(B) can be manufactured. One formed by the stacking is herein expressed as the element, but may be said to be the stacking body. A pressure of approximately 500 to 2000 psi is used when performing the stacking. The element 98 is compressed after the stacking. A pressure of approximately 500 to 3000 psi is used when performing the compression.

The degreasing and burning processes are performed on the element 98 formed by the stacking and compression. After the degreasing process is performed at approximately 300° C., the burning process is performed at approximately 800 to 900° C. In other words, the simultaneous burning of the electrode patterns 91, 93, 95, and 97 and the element 98 are performed.

The gap between the first gap electrode unit 95a and the second gap electrode unit 91a and the gap between the third gap electrode unit 97a and the fourth gap electrode unit 93a has a desired numerical value (approximately 10 μm) by subjecting to the stacking, compressing, burning processes in sequence. In other words, the gap between the gap electrode units is controlled to the thickness of the sheet interposed between the gap electrode units overlapped up and down, such that the desired gap can be implemented much easier than the existing printing method.

The element 98 is rotated so that the side surface to which the upper and lower gap electrode units 95a, 91a; 97a, 93a are exposed to be overlapped with each other faces upward, thereby printing the discharge medium 84. The discharge medium 84 is printed on the gap electrode units 95a and 91a and the gap electrode units 97a and 93a. When the discharge medium 84 is printed, it is the same as FIG. 12(C). Herein, the material of the discharge medium 84 is the same as the material of the discharge medium of the first embodiment as described above.

The printed discharge medium 84 is firmly bonded to the element 98 by a heat treatment. In other words, the discharge medium 84 is hardened. Since the hardening of the discharge medium 84 is performed after the simultaneous burning of the electrode patterns 91, 93, 95, and 97 and the element 98, the problem of the deterioration of the element 98 due to vaporization components from the discharge medium in the simultaneous burning method (FIG. 2) can be solved. In other words, even though the electrode patterns 91, 93, 95, and 97 and the element 98 are simultaneously fired, the discharge medium 84 is formed at the outer side surface of the element 98, the material selection of the discharge medium does not need to be limited.

Then, the external terminals 80a, 82a, 80b, and 82b, which are connected to the first internal electrode unit 95b, the second internal electrode unit 91b, the third internal electrode unit 97b, and the fourth internal electrode unit 93b, are formed at both outer side surfaces in a length direction of the element 98 as shown in FIG. 12(D). It is obvious to those skilled in the art that the external terminals 80a, 82a, 80b and 82b may be formed in the same method as the first embodiment. Therefore, the description thereof will not be repeated. The external terminal 80a is connected to the first internal electrode unit 95b and the external terminal 82a is connected to the first internal electrode unit 97b. The external terminal 80b is connected to the second internal electrode unit 91b and the external terminal 82b is connected to the second internal electrode unit 93b.

In order to bond the external terminals 80a, 82a, 80b and 82b to the element 98, they are baked at a predetermined temperature. Thereby, the two-channel array type of the surge absorber shown in FIG. 11 is completed.

The surge absorber of the third embodiment has the gap electrode for each channel, but since the gap electrode for each channel is exposed to the cuter side surface in a width direction of the element 98, the surge absorber has the same effect as the first and second embodiments as described above.

Although the third embodiment does not show the concave part as shown in the second embodiment, the surge absorber of the third embodiment may be formed with the concave part and the concave part may be filled with the discharge medium. Thereby, the third embodiment has the same effect as the second embodiment by forming the discharge medium in the concave part.

### Fourth Embodiment

FIG. 13 is a view for schematically showing a structure of a surge absorber according to a fourth embodiment of the present invention. The fourth embodiment is a case where the number of channels is name than the third embodiment. The surge absorber of the fourth embodiment indicates a four-channel array type of the surge absorber.

In the surge absorber of FIG. 13, a plurality of first external terminals 100a, 102a, 104a, and 106a are formed to be spaced from each other at the first outer side surface in a length direction of the corresponding element. A plurality of second external terminals 100b, 102b, 104b, and 106b are formed at the second outer side surface (that is, a surface existing at a position opposite to the first outer side surface in a length direction) in a length direction of the element. Discharge mediums 108, which covers the gap between the gap electrode units (not shown) exposed to the corresponding outer side surface, are printed at both cuter side surfaces in a width direction in the element.

The four-channel array type of the surge absorber of FIG. 13 generates the gap discharge in the gap electrode units exposed to both outer side surfaces in a width direction of the element.

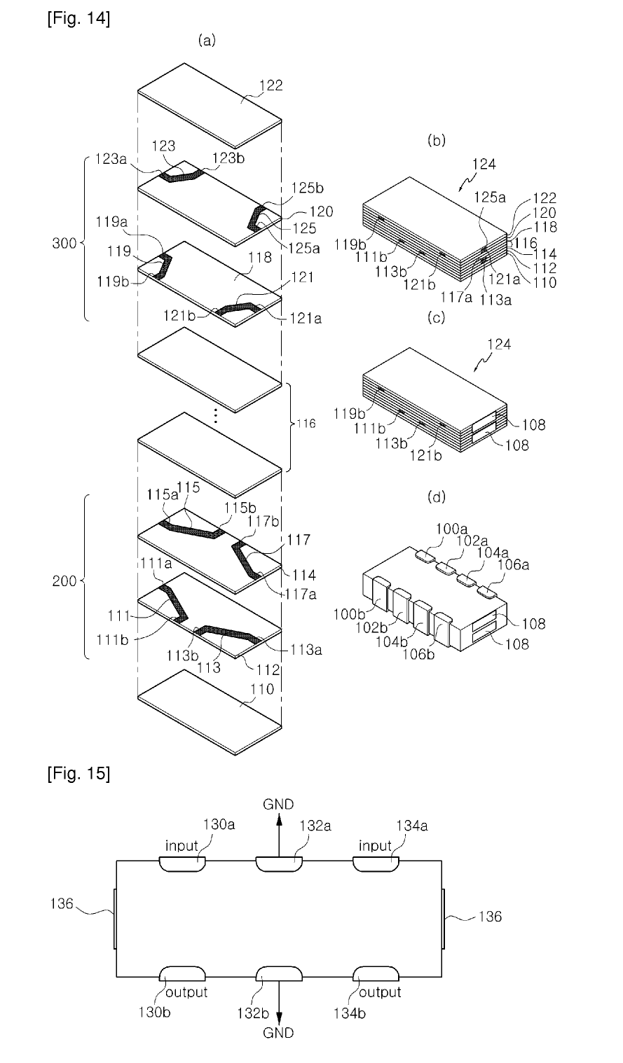

FIG. 14 is a view for explaining a process for manufacturing the surge absorber of FIG. 13. The structure of the surge absorber according to the fourth embodiment can be better understood through the following description.

First, a process for manufacturing the plurality of sheets 110, 112, 114, 116, 118, 120, and 122 can be appreciated by those skilled in the art based on the first embodiment described above and the description thereof will not be repeated.

When the manufacturing of the plurality of sheets 110, 112, 114, 116, 118, 120, and 122 is completed, as shown in FIG. 14(A), a first electrode pattern 115 that includes a first gap electrode unit 115a and a first internal electrode unit 115 and a third electrode pattern 117 that includes a third gap electrode unit 117a and a third internal electrode unit 117b are printed to be spaced from each other on the manufactured sheet 114. A second electrode pattern 111 that includes a second gap electrode unit 111a and a second internal electrode unit 111b and a third electrode pattern 113 that includes a fourth gap electrode unit 113a and a fourth internal electrode unit 114b are printed to be spaced from each other on the manufactured sheet 112. A fifth electrode pattern 123 that includes a fifth gap electrode unit 123a and a fifth internal electrode unit 123b and a seventh electrode pattern 125 that includes a seventh gap electrode unit 125a and a seventh internal electrode unit 125b are printed to be spaced from each other on the manufactured sheet 120. A sixth electrode pattern 119 that includes a sixth gap electrode unit 119a and a sixth internal electrode unit 119b and an eighth electrode pattern 121 that includes an eighth gap electrode unit 121a and an eighth internal electrode unit 121b are printed to be spaced from each other on the manufactured sheet 118. In FIG. 14(A), the two-channel array type of the two surge absorbers is combined so as to indicate the four-channel array type of the surge absorber. In other words, in FIG. 14(A), each of the reference numerals 200 and 300 indicates a configuration for implementing the two-channel type of the surge absorber. Although the exposed directions of the gap electrode unit and the internal electrode unit are not described separately, it can be appreciated by those skilled in the art from the foregoing embodiments and therefore, the description thereof will not be repeated.

In FIG. 14(A), the electrode patterns 115, 111, 117, 113, 123, 119, 120, and 121 are obliquely formed. This is to minimize the overlapped area between the gap electrode units overlapped up and down as in the foregoing embodiments. In other words, if the overlapped area between the gap electrode units overlapped up and down is minimized, the low capacitance can be implemented. Therefore, when it is applied to the four-channel high-speed line, the delay and distortion of the signal can be removed.

In FIG. 14(A), it is preferred that the sheet 116 is understood as a dummy set. The plurality of sheets 116 are interposed between the sheet 114 and the sheet 118. The sheet 116 is interposed in the middle of the sheet 114 and the sheet 118, such that the space capable of accurately printing the discharge medium 108 is provided. In FIG. 14(A), the first gap electrode unit 115a and the second gap electrode unit 111a form a pair, the third gap electrode unit 117a and the fourth gap electrode unit 113a forms a pair, a fifth gap electrode unit 123a and a sixth gap electrode unit 119a forms a pair, and a fifth gap electrode unit 125a and an eighth gap electrode unit 121a forms a pair. A generation of unnecessary capacitance (that is, capacitance between the gap electrode units formed facing each other up and down) between the sheet 121 and the sheet 114 is removed by the plurality of sheets 116.

In FIG. 14(a), the two electrode patterns are formed on each of the four sheets. This is to minimize the number of sheet as in the third embodiment described above to minimize the size of the element. For example, one electrode pattern may be formed on each of the eight sheets. Thereby, the surge absorber becomes the array form using the structure of the first embodiment, such that the number of sheets required in the fourth embodiment is excessive, thereby making the size of the element (stacking body) large. Although the size of the element is somewhat large, it is understood that the structure of the example described above should be construed to be included within the scope of the present invention.

Thereafter, the sheet 112 is stacked on the sheet 110 that is the lowermost layer and the sheet 114 is then stacked on the sheet 112. The sheet 116 is stacked on the sheet 114 and the sheet 118 is then stacked on the sheet 116. The sheet 122 serves as the protective sheet. By such stacking, the element 124 such as FIG. 14(B) can be manufactured. One formed by the stacking is herein expressed as the element, but may be said to be the stacking body. A pressure of approximately 500 to 2000 psi is used when performing the stacking. The element 124 is compressed after the stacking. A pressure of approximately 500 to 3000 psi is used when performing the compression.

The degreasing and burning processes are performed on the element 124 formed by the stacking and compression. After the degreasing process is performed at approximately 300° C., the burning process is performed at approximately 800 to 900° C. In other words, the simultaneous burning of the electrode patterns 111, 113, 115, 117, 119, 121, 123, and 125 and the element 124 are performed.

The gap between the gap electrode units (that is, gap between the gap electrode units forming a pair up and down) has a desired numerical value (approximately 10 μm) by subjecting to the stacking, compressing, burning processes in sequence. In other words, the gap of the gap electrode gap is controlled to the thickness of the sheet between the gap electrode units overlapped up and down, such that the desired gap can be implemented much easier than the existing printing method.

The discharge medium 108 is printed on the element 124 as shown in FIG. 14(C). The material of the discharge medium 108 is considered to be the same as the material of the discharge medium of the first embodiment. It can be appreciated by those skilled in the art based on the descriptions of the foregoing embodiments that the printing of the discharge medium 108 can be performed as shown in FIG. 14(C) and therefore, the description thereof will not be repeated.

In FIG. 14, the gap electrode units 123a, 119a; 115a, 111a, 125a, 121a; 117a, 113a, which are exposed to both outer side surfaces in a width direction of the element 124, are arranged in a row at the upper and lower, but this arrangement can be disregarded in order to print the discharge medium 108 so that the upper discharge medium 108 and the lower discharge medium 108 are easily separated from each other. For example, in FIG. 14(C), the gap electrode unit may be controlled so that the upper discharge medium 108 is obliquely printed at a left portion of the corresponding surface and the lower discharge medium 108 is obliquely printed at a right portion of the corresponding surface. The structure of the example described above should be construed to be included in the scope of the present invention.

The printed discharge medium 108 is firmly bonded to the element 98 by a heat treatment. In other words, the discharge medium 108 is hardened. Since the hardening of the discharge medium 108 is performed after the simultaneous burning of the electrode patterns 111, 113, 115, 117, 119, 121, 123, and 125 and the element 124, the problem of the deterioration of the element 124 due to vaporization components from the discharge medium in the simultaneous burning method (FIG. 2) can be solved. In other words, even though the electrode patterns 111, 113, 115, 117, 119, 121, 123, and 125 and the element 124 are simultaneously fired, the discharge medium 108 is formed at the cuter side surface of the element 124, the range of the material selection of the discharge medium may be widened.

Then, the external terminals 100a, 102a, 104a, 106a; 100b, 102b, 104b, and 106b are formed at both outer side parts in a length direction of the element 124 using a general termination system. It is obvious to those skilled in the art that the external terminals 100a, 102a, 104a, 106a; 100b, 102b, 104b, and 106b may be formed in the same method as the foregoing embodiments and therefore, the description thereof will not be repeated. The external terminal 100a is connected to the first internal electrode unit 115b and the external terminal 104a is connected to the third internal electrode unit 117b. The external terminal 106a is connected to the seventh internal electrode unit 125b and the external terminal 100b is connected to the sixth internal electrode unit 119b. The external terminal 102b is connected to the second internal electrode unit 111b. The external terminal 104b is connected to the fourth internal electrode unit 113b. The external terminal 106b is connected to the eighth internal electrode 121b.

In order to bond the external terminals 100a, 102a, 104a, 106a; 100b, 102b, 104b, and 106b to the element 124, they are baked at a predetermined temperature. Thereby, the two-channel array type of the surge absorber shown in FIG. 13 is completed.

The surge absorber of the fourth embodiment has the gap electrode for each channel, but since the gap electrode for each channel is exposed to the cuter side surface in a width direction of the element 124, the surge absorber has the same effect as the first and second embodiments as described above.

Although the fourth embodiment does not show the concave part as shown in the second embodiment, the surge absorber of the fourth embodiment may be formed with the concave part and the concave part may be filled with the discharge medium. Thereby, the fourth embodiment has the same effect as the second embodiment by forming the discharge medium in the concave part.

The above-mentioned third embodiment describes the two-channel array type of the surge absorber and the above-mentioned fourth embodiment describes the four-channel array type of the surge absorber. When expanding, an array type of the surge absorber, such as six-channel, eight-channel etc., can be implemented. The array type of the surge absorber expanded to a six-channel, an eight-channel, etc. should be construed to be included within the scope of the present invention.

### Fifth Embodiment

FIG. 15 is a view for schematically showing a structure of a surge absorber according to a fifth embodiment of the present invention. A surge absorber according to the fifth embodiment, which is a two-channel array type, has three terminals (that is, input external terminal, output external terminal, ground external terminal) for each channel. The surge absorber shown in FIG. 15 is used when the gap electrode units for the discharge is formed at both outer side surfaces in a width direction of the element and the ground external terminals are formed at both outer side surfaces in a length direction of the element.

In the surge absorber of FIG. 15, the first input external terminal 130a, the ground external terminal 132a, and the second input external terminal 134a are formed to be spaced from each other at the first outer side surface in a length direction of the element. The first input external terminal 130a, the ground external terminal 132a, and the second input external terminal 134a is formed to be spaced from each other at the second outer side surface (that is, a surface existing at a position opposite to the first outer side surface in a length direction) in a length direction of the element.

Discharge mediums 136, which cover the gap between the gap electrode units (not shown) exposed to the corresponding outer side surface, are printed at both outer side surfaces in a width direction of the element.

When necessary, a configuration, which does not have any one of two ground external terminals 132a and 132b, can be permitted.

FIG. 16 is a view for explaining a manufacturing process of the surge absorber of FIG. 15. Through the following description, the structure of the surge absorber according to the fifth embodiment can be name accurately understood.

First, the process for manufacturing a plurality of sheets 140, 142, 144, and 146 can be appreciated by those skilled in the art based on the first embodiment described above and therefore, the description thereof will not be repeated.

When the manufacturing of the plurality sheets 140, 142, 144, and 146 is completed, as shown in FIG. 16(A), the first internal electrode pattern 143 and the second internal electrode pattern 145 are printed to be spaced from each other on the manufactured sheet 144. The first and second internal electrode patterns 143 and 145 are printed by paste using Ag powders, for example. The first and second internal electrode patterns 143 and 145 are printed in a Y-letter shape, which is a capital of English Alphabet. The first internal electrode pattern 143 includes an internal electrode unit 143b that is connected to the first input external terminal 130a, an internal electrode unit 143c that is connected to the first output external terminal 130b, and a first gap electrode unit 143a that is integrally with internal electrode units 143b and 143c and is exposed to any one outer side surface in a width direction of the corresponding sheet 144. On the other hand, the second internal electrode pattern 145 includes an internal electrode unit 145b that is connected to the second input external terminal 134a, an internal electrode unit 145c that is connected to the second output external terminal 134b, and an second gap electrode unit 145a that is integrally with internal electrode units 145b and 145c and is exposed to the other cuter side surface in a width direction of the corresponding sheet 144.

An internal ground pattern 141 in a cross shape is printed on the manufactured sheet 142. The internal ground pattern 141 is printed by paste using Ag powders, for example. The internal ground pattern 141 includes an internal electrode unit 141c that is connected to the ground external terminal 132a, an internal electrode unit 141d that is connected to the ground external terminal 132b, a first ground gap electrode unit 141a and a second ground gap electrode unit 141b that are integrally with the internal electrode units 141c and 141d but is exposed in a direction facing each other. When necessary, a configuration, which does not have any one of two ground external terminals 132a and 132b, can be permitted. In this case, it can be considered that any one of the two internal electrode units 141c and 141d is removed.

In FIG. 16(A), the two internal electrode patterns 143 and 145 are formed in a Y-letter, which is a capital of English Alphabet and the internal ground pattern 141 is formed in a cross shape. This is to minimize the overlapped area between the gap electrode units overlapped up and down when the sheets 142 and 144 are stacked. In other words, if the overlapped area between the gap electrode units overlapped up and down is minimized, the low capacitance can be implemented. Therefore, when it is applied to the two-channel high-speed line, the delay and distortion of the signal can be removed.

In FIG. 16(A), the two internal electrodes 143 and 145 are formed on one sheet 144 and the internal ground pattern 141 in a cross shape is formed on one sheet 142. This is to implement the two-channel array type of the surge absorber that minimizes the number of sheets. Although not shown, for example, this can be changed in a form that one internal electrode pattern may be formed on each of two sheets and one internal ground pattern in a T-letter or an L-letter shape, which is a capital of English Alphabet, is formed on each of other two sheets. However, the number of sheets required in the fifth embodiment is excessive, thereby making the size of the element (stacking body) large. Although the size of the element is somewhat large, it is understood that the structure of the example described above should be construed to be included within the scope of the present invention.

Thereafter, the sheet 142 is stacked on the sheet 140 that is the lowermost layer and the sheet 144 is then stacked on the sheet 142. The sheet 146 is stacked on the sheet 144. The sheet 146 serves as the protective sheet. By such stacking, the element 148 such as FIG. 16(B) is formed. One formed by the stacking is herein expressed as the element, but may be said to be the stacking body. A pressure of approximately 500 to 2000 psi is used when performing the stacking. The element 148 is compressed after the stacking. A pressure of approximately 500 to 3000 psi is used when performing the compression.

The degreasing and burning processes are performed on the element 148 formed by the stacking and compression. After the degreasing process is performed at approximately 300° C., the burning process is performed at approximately 800 to 900° C. In other words, the simultaneous burning of the internal electrode patterns 143 and 145, the internal ground pattern 141, and the element 148 are performed.

The gap between the gap electrode units 143a, 141a; 145a, 141b overlapped up and down has a desired numerical value (approximately 10 μm) by subjecting to the stacking, compressing, burning processes in sequence. In other words, the gap of the gap electrode gap is controlled to the thickness of the sheet interposed between the gap electrode units overlapped up and down, such that the desired gap can be implemented much easier than the existing printing method.

A discharge medium 136 is printed on the element 148 as shown in FIG. 16(C). The material of the discharge medium 136 is considered to be the same as the material of the discharge medium 36 of the first embodiment. It can be appreciated by those skilled in the art based on the descriptions of the foregoing embodiments that the printing of the discharge medium 136 can be performed as shown in FIG. 16(C) and therefore, the description thereof will not be repeated.

The printed discharge medium 136 is firmly bonded to the element 148 by a heat treatment. In other words, the discharge medium 136 is hardened. Since the hardening of the discharge medium 136 is performed after the simultaneous burning of the in ternal electrode patterns 143 and 145, the internal ground pattern 141, and the element 148, the problem of the deterioration of the element 124 due to vaporization components from the discharge medium in the existing simultaneous burning method (FIG. 2) can be solved. In other words, even though the internal electrode patterns 143 and 145, the internal ground pattern 141, and the element 148 are simultaneously fired, since the discharge medium 136 is formed at the outer side surface of the element 148, the range of the material selection of the discharge medium may be widened.

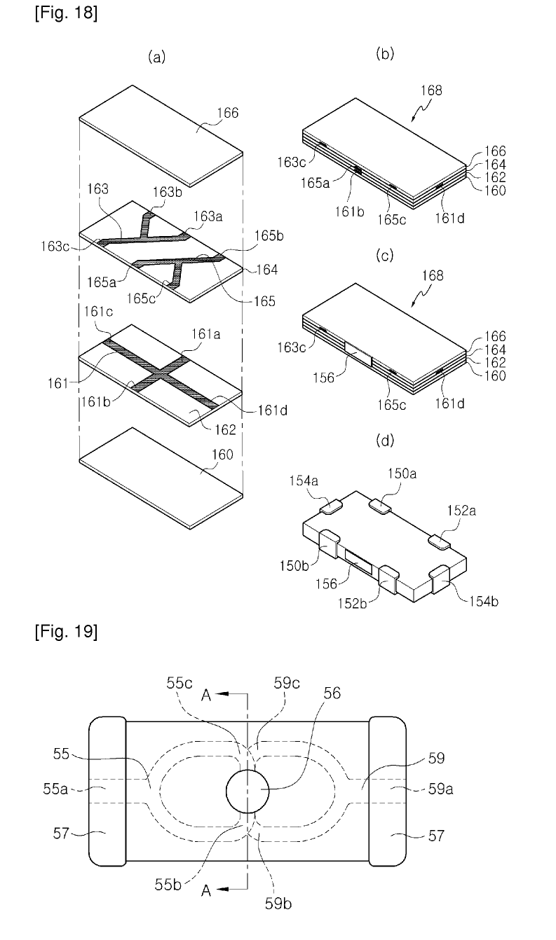

Then, as shown in FIG. 18(D), the external terminals 130a, 132a, 134a, 130b, 132b, and 134b are formed at both outer side surface parts in a length direction of the element 148 using a general termination system. It is obvious to those skilled in the art that the external terminals 130a, 132a, 134a, 130b, 132b, and 134b may be formed in the same method as the foregoing embodiments and therefore, the description thereof will not be repeated. The first input external terminal 130a is connected to the exposed internal electrode unit 143b. The ground external terminal 132a is connected to the exposed internal electrode unit 141c. The second input external terminal 134a is connected to the exposed internal electrode unit 145b. The first output external terminal 130b is connected to the exposed internal electrode unit 143c. The ground external terminal 132b is connected to the exposed internal electrode unit 141d. The second output external terminal 134b is connected to the exposed internal electrode unit 145c.

In order to bond the external terminals 130a, 132a, 134a, 130b, 132b, and 134b to the element 148, they are baked at a predetermined temperature. Thereby, the two-channel array type of the surge absorber shown in FIG. 15 is completed.

The surge absorber of the fifth embodiment has the same effect as the first and second embodiments as described above.

Although the fifth embodiment does not show the concave part as shown in the second embodiment, the surge absorber of the fifth embodiment may be formed with the concave part and the concave part may be filled with the discharge medium. Thereby, the fifth embodiment has the same effect as the second embodiment by forming the discharge medium in the concave part.

The above-mentioned fifth embodiment which is the two-channel array type of the surge absorber having three terminals for each channel, can provides the easiness of wirings and the operating stability on a PCB as compared to the array type of the surge absorber, such as a two-channel, a four-channel, etc., having two terminals for each channel.

### Sixth Embodiment

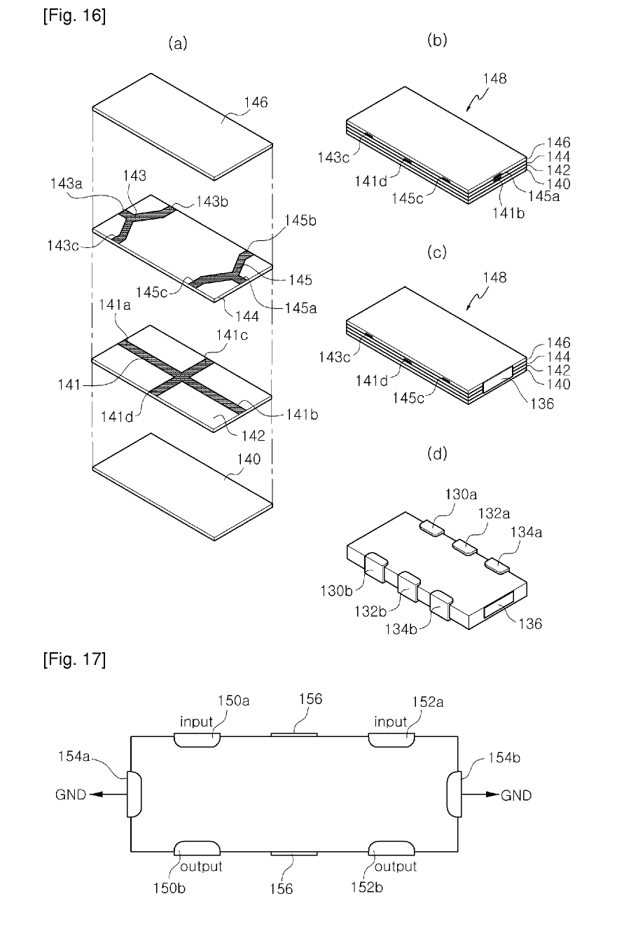

FIG. 17 is a view for schematically showing a structure of a surge absorber according to a sixth embodiment of the present invention. The surge absorber of the sixth embodiment, which is a two-channel array type, has three terminals (that is, input external terminal, output external terminal, ground external terminal) for each channel. The surge absorber shown in FIG. 15 is used when the gap electrode units for the discharge is formed at both outer side surfaces in a length direction of the element and the ground external terminals are formed at both outer side surfaces in a width direction of the element.

In the surge absorber of FIG. 17, the first input external terminal 150a and the second input external terminal 152a are formed to be spaced from each other at the first outer side surface in a length direction of the element. The first output external terminal 150b and the second output external terminal 152b is formed to be spaced from each other at the second outer side surface (that is, a surface existing at a position opposite to the first outer side surface in a length direction) in a length direction of the element. The ground external terminals 154a and 154b are formed at both cuter side surfaces in a width direction of the element.

Discharge mediums 156, which cover the gap between the exposed gap electrode units (not shown), are printed at the first and second outer side surfaces in a length direction of the element.

When necessary, a configuration, which does not have any one of two ground external terminals 154a and 154b, can be permitted.

FIG. 18 is a view for explaining a manufacturing process of the surge absorber of FIG. 17. Through the following description, the structure of the surge absorber according to the sixth embodiment can be name accurately understood.

First, the process for manufacturing a plurality of sheets 160, 162, 164, and 166 can be appreciated by those skilled in the art based on the first embodiment described above and therefore, the description thereof will not be repeated.

When the manufacturing of the plurality sheets 160, 162, 164, and 166 is completed, as shown in FIG. 18(A), the first internal electrode pattern 163 and the second internal electrode pattern 165 are printed to be spaced from each other on the manufactured sheet 164. The first and second internal electrode patterns 163 and 165 are printed by paste using Ag powders, for example. The first and second internal electrode patterns 163 and 165 are printed in a y-letter shape, which is a small letter of English Alphabet. The first internal electrode pattern 163 includes an internal electrode unit 163b that is connected to the first input external terminal 150a, an internal electrode unit 163c that is connected to the first output external terminal 150b, and a first gap electrode unit 163a that is integrally with internal electrode units 163b and 163c and is exposed to any one outer side surface in a length direction of the corresponding sheet 164. On the other hand, the second internal electrode pattern 165 includes an internal electrode unit 165c that is connected to the second input external terminal 152a, an internal electrode unit 165c that is connected to the second output external terminal 152b, and an second gap electrode unit 165a that is integrally with internal electrode units 165b and 165c and is exposed to the other cuter side surface in a length direction of the corresponding sheet 164.

An internal ground pattern 161 in a cross shape is printed on the manufactured sheet 162. The internal ground pattern 161 is printed by paste using Ag powders, for example. The internal ground pattern 161 includes an internal electrode unit 161c that is connected to the ground external terminal 154a, an internal electrode unit 161d that is connected to the ground external terminal 154b, a first ground gap electrode unit 161a and a second ground gap electrode unit 161b that are integrally with the internal electrode units 161c and 161d but is exposed in a direction facing each other. When necessary, a configuration, which does not have any one of two ground external terminals 154a and 154b, can be permitted. In this case, it can be considered that any one of the two internal electrode units 161c and 161d is removed.

In FIG. 18(A), the two internal electrode patterns 163 and 165 are formed in a Y-letter, which is a capital of English Alphabet and the internal ground pattern 161 is formed in a cross shape. This is to minimize the overlapped area between the gap electrode units overlapped up and down when the sheets 162 and 164 are stacked. In other words, if the overlapped area between the gap electrode units overlapped up and down is minimized, the low capacitance can be implemented. Therefore, when it is applied to the four-channel high-speed line, the delay and distortion of the signal can be removed.

In FIG. 18(A), the two internal electrodes 163 and 165 are formed on one sheet 164 and the internal ground pattern 161 in a cross shape is formed on one sheet 162. This is to implement the two-channel array type of the surge absorber that minimizes the number of sheets. Although not shown, for example, this can be changed in a form that one internal electrode pattern may be formed on each of two sheets and one internal ground pattern in a T-letter or an L-letter shape, which is a capital of English Alphabet, is formed on each of other two sheets. However, the number of sheets required in the sixth embodiment is excessive, thereby making the size of the element (stacking body) large. Although the size of the element is somewhat large, it is understood that the structure of the example described above should be construed to be included within the scope of the present invention.

Thereafter, the sheet 162 is stacked on the sheet 160 that is the lowermost layer and the sheet 164 is then stacked on the sheet 162. The sheet 166 is stacked on the sheet 164. The sheet 166 serves as the protective sheet. By such stacking, the element 168 such as FIG. 18(B) is formed. One formed by the stacking is herein expressed as the element, but may be said to be the stacking body. A pressure of approximately 500 to 2000 psi is used when performing the stacking. The element 168 is compressed after the stacking. A pressure of approximately 500 to 3000 psi is used when performing the compression.

The degreasing and burning processes are performed on the element 168 formed by the stacking and compression. After the degreasing process is performed at approximately 300° C., the burning process is performed at approximately 800 to 900° C. In other words, the simultaneous burning of the internal electrode patterns 163 and 165, the internal ground pattern 161, and the element 168 are performed.

The gap between the gap electrode units 163a, 161a; 165a, 161b overlapped up and down has a desired numerical value (approximately 10 μm) by subjecting to the stacking, compressing, burning processes in sequence. In other words, the gap of the gap electrode gap is controlled to the thickness of the sheet interposed between the gap electrode units overlapped up and down, such that the desired gap can be implemented much easier than the existing printing method.

A discharge medium 156 is printed on the element 168 as shown in FIG. 18(C). The material of the discharge medium 156 is considered to be the same as the material of the discharge medium 36 of the first embodiment. It can be appreciated by those skilled in the art based on the descriptions of the foregoing embodiments that the printing of the discharge medium 156 can be performed as shown in FIG. 18(C) and therefore, the description thereof will not be repeated.

The printed discharge medium 156 is firmly bonded to the element 168 by a heat treatment. In other words, the discharge medium 156 is hardened. Since the hardening of the discharge medium 156 is performed after the simultaneous burning of the internal electrode patterns 163 and 165, the internal ground pattern 161, and the element 168, the problem of the deterioration of the element 124 the to vaporization components from the discharge medium in the existing simultaneous burning method (FIG. 2) can be solved. In other words, even though the internal electrode patterns 163 and 165, the internal ground pattern 161, and the element 168 are simultaneously fired, since the discharge medium 156 is formed at the outer side surface of the element 168, the range of the material selection of the discharge medium may be widened.

Then, as shown in FIG. 18(D), the external terminals 150a, 150b, 152a, 152b, 154a, and 154b are formed at both outer side surface parts in a length direction of the element 168 using a general termination system. It is obvious to those skilled in the art that the external terminals 150a, 150b, 152a, 152b, 154a, and 154b may be formed in the same method as the foregoing embodiments and therefore, the description thereof will not be repeated. The first input external terminal 150a is connected to the exposed internal electrode unit 163b. The first output external terminal 150b is connected to the exposed internal electrode unit 163c. The second output external terminal 152b is connected to the exposed internal electrode unit 165c. The ground external terminal 154a is connected to the exposed internal electrode unit 161c. The ground external terminal 154b is connected to the exposed internal electrode unit 161d.

In order to bond the external terminals 150a, 150b, 152a, 152b, 154a, and 154b to the element 168, they are baked at a predetermined temperature. Thereby, the two-channel array type of the surge absorber shown in FIG. 17 is completed.

The surge absorber of the sixth embodiment has the same effect as the first and second embodiments as described above.

Although the sixth embodiment does not show the concave part as shown in the second embodiment, the surge absorber of the fifth embodiment may be formed with the concave part and the concave part may be filled with the discharge medium. Thereby, the sixth embodiment has the same effect as the second embodiment by forming the discharge medium in the concave part.

The above-mentioned sixth embodiment which is the two-channel array type of the surge absorber having three terminals for each channel, can provides the easiness of wirings and the operating stability on a PCB as compared to the array type of the surge absorber, such as a two-channel, a four-channel, etc., having two terminals for each channel.

### Seventh Embodiment

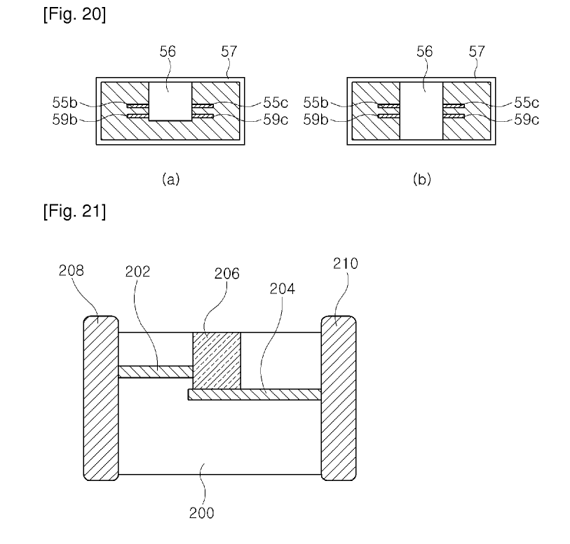

FIG. 19 is a view for schematically showing a structure of a surge absorber according to a seventh embodiment of the present invention and FIG. 20 is a cross-sectional view taken along the line A-A of FIG. 19.

The seventh embodiment may be a modified example of the above-mentioned second embodiment. Those skilled in the art can sufficiently derive the structure and manufacturing process of the seventh embodiment from the description of the second embodiment. Hereinafter, the description of the same or similar portions will not be repeated and only the difference will be described.

When comparing the seventh embodiment with the second embodiment, the second embodiment forms the discharge units (that is, units in which the gap discharge is generated) at both outer side surfaces in a length direction of the element, hit the seventh embodiment forms the discharge unit inside the center of the element. In other words, the seventh embodiment forms a hole in the central portion of the element and exposes the gap electrode units 55b, 59b; 55c, 59c of the first and second electrode patterns 55 and 59 to an inner side surface of the hole, wherein the discharge medium 56 is filled in the hole. By forming the discharge unit in the central portion of the element in the seventh embodiment, the shape of the first and second electrode patterns 55 and 59 has a slight difference from the first and second electrode patterns of the second embodiment.

Herein, the hole in which the discharge medium 56 may be formed at a predetermined depth from the center of the upper surface of the element downwardly as shown in FIG. 20(A) and is formed to penetrate through the central portion of the element as shown in FIG. 20(B).

In order to manufacture the surge absorber of FIG. 20(A), the centers of several sheets are perforated in the manufacturing process of the sheet and the post-process should be performed, so as to satisfy the depth of the hole to be formed. According to the structure of FIG. 20(A), a case where the hole having a uniform diameter cannot be obtained in the stacking and compressing processing of the sheets including the perforated sheets. If the hole has a non-uniform diameter, even though the burning process is performed later, the close adhesion between the discharge medium 56 and the gap electrode units 55b, 59b; 55c, 59c are damaged. However, whether the hole having the uniform diameter can be obtained or not is due to the difference in the manufacturing facility, the surge absorber can sufficiently be used by the structure of FIG. 20(A).

The surge absorber of FIG. 20(B) fills the discharge medium by perforating the hole followed by performing the burning process after the stacking and compression of the plurality of sheets, making it possible to obtain the hole having a uniform diameter as compared to FIG. 20(A). Thereby, the close adhesion between the discharge medium 56 and the gap electrode units 55b, 59b; 55c, 59c) is excellent as compared to the FIG. 20(A). Further, the formation of the hole can be performed at one time, such that the manufacturing process of the surge absorber is simpler as compared to that of FIG. 20(A).

Meanwhile, in the above-mentioned seventh embodiment, the hole in which the discharge medium 56 is filled is formed at the central portion of the element, but the formation position of the hole is not limited to the central portion.

Although the above-mentioned seventh embodiment describes as the modified example of the second embodiment, if any one of the two electrode patterns 55 and 58 is removed, the seventh embodiment can be considered as the modified example of the above-mentioned first embodiment.

### Eighth Embodiment

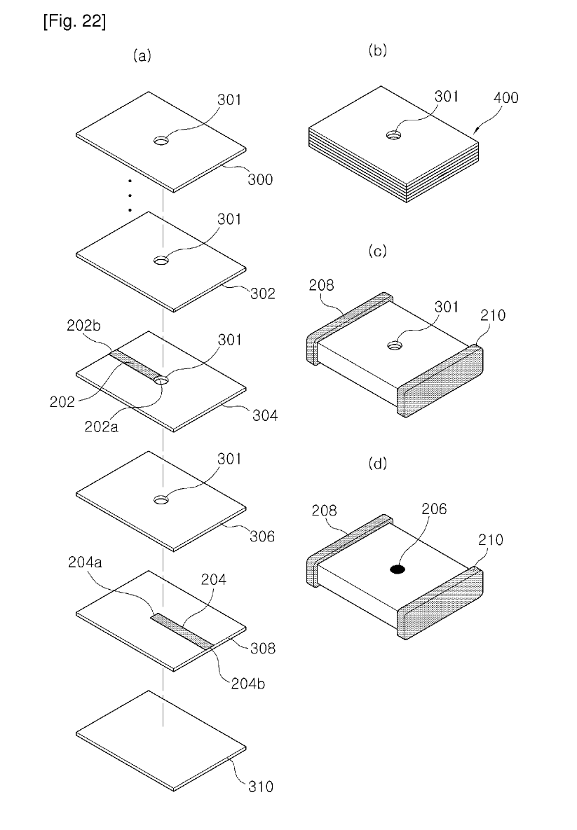

FIG. 21 is a cross-sectional view of a surge absorber according to an eighth embodiment of the present invention and FIG. 22 is a view adopted for explaining a manufacturing process of the surge absorber of FIG. 21. The eighth embodiment may be the modified example of the first embodiment. In other words, in the first embodiment, the hole is not formed in the element, but in the eighth embodiment, the hole is formed in the element and the gap electrode is exposed through the hole.

First, a manufacturing process of the plurality of sheets 300, 302, 304, 306, 308, and 310 will not be repeated since it can sufficiently be understood by those skilled in the art.

When the manufacturing of the plurality of sheets 300, 302, 304, 306, 308, and 310 is completed, as shown in FIG. 22(A), the hole is formed in the central portion of the forming sheet 300, 302, 304, and 306. The diameter of the hole 301 is the same on the order of 60 to 300 μm. The hole 301 can be formed by a usual punching machine (not shown). The cross section shape of the hole 301 may be a circle or an angled shape, such as a square, etc.

As shown in FIG. 22(A), the first electrode pattern 202 is printed on the sheet 304 and the second electrode pattern 204 is printed on the sheet 308. The first and second electrode patterns 202 and 204 are printed by silver paste using Ag powders. The first and second electrode patterns 202 and 204 each have the gap electrode unit and the internal electrode unit. The first gap electrode unit 202a of the first electrode pattern 202 is exposed to the inner side surface of the hole 301. The first internal electrode unit 202b of the first electrode pattern 202 is exposed to the outer side surface in a width direction of the corresponding sheet 304. The second electrode pattern 204 is formed in a straight line to be longer than the length of the first electrode pattern 202. The second internal electrode unit 204b of the second electrode pattern 204 is exposed to the outer side surface (that is, a surface in a direction opposite to the first internal electrode unit 202b) in a width direction of the corresponding sheet 308. The second gap electrode unit 204a of the second electrode pattern 204 is positioned in a direction opposite to the second internal electrode unit 204b and is disposed at the bottom of the hole 301 after completing the sheet stacking later.

Then, the sheet 308 is stacked on the sheet 310 that is the lowermost layer and the sheet 306 is then stacked on the sheet 308. The sheet 304 is stacked on the sheet 306, the sheet 302 is stacked on the sheet 304 and the sheet 300 is then stacked on the sheet 302. If the gap having a desired numerical value between the first gap electrode unit 202 and the second gap electrode unit 204a can be obtained excepting for the sheet 306, the sheet 306 can be excluded. The element 400 of FIG. 22(B) is formed by the stacking. One formed by the stacking is herein expressed as the element, but may be said to be the stacking body. A pressure of approximately 500 to 2000 psi is used when performing the stacking. The element 98 is compressed after the stacking. A pressure of approximately 500 to 3000 psi is used when performing the compression.

Then, the degreasing and burning processes are performed on the element 400 formed by the stacking and compression. After the degreasing process is performed at approximately 300° C., the burning process is performed at approximately 800 to 900° C.

The gap between the first gap electrode pattern 202 and the second gap electrode pattern 204 has a desired numerical value (approximately 10 μm) by subjecting to the stacking, compressing, burning processes in sequence. In other words, the gap between the first and second gap electrode units 202a and 204a is controlled to 10 μm. In particular, according to the eighth embodiment, since there is little the overlapped area between the first gap electrode unit 202a and the second gap electrode unit 204a, the eight embodiment forms lower capacitance than the first embodiment and its modified embodiments, which can inevitably generate the overlapped area. In FIG. 21, the slight overlapped area between the first gap electrode unit 20a and the second gap electrode unit 204a is shown. However, if the printing length of the second electrode pattern 204 is controlled, the overlapped area between the first gap electrode unit 202a and the second gap electrode unit 204a can be reamed. Therefore, the structure of the eighth embodiment can form much lower capacitance than the first embodiment and its modified examples.

Then, as shown in FIG. 22(C), the external terminals 208 and 210 are formed at both outer side surfaces in a width direction of the element 400 by using the termination system. It can be obvious to those skilled in the art that the external terminals 208 and 210 can be formed in the same method as the above-mentioned embodiments and therefore, the description thereof will not be repeated. The external terminal 208 is connected to the exposed first internal electrode unit 202b. The external terminal 210 is connected to the exposed second internal electrode unit 204.

Then, as shown in FIG. 22(D), the discharge medium is filled in the hole 301. The material of the discharge medium 206 is the same as the material of the discharge medium 36 of the first embodiment.

Finally, the heat treatment is performed at 150° C. to 200° C. in order to bond the external terminals 208 and 210 to the element 400 and well bond the discharge medium 206 in the hole 301 to its neighborhood.

The surge absorber of the eighth embodiment completed according the above-mentioned method has the same effect as the first embodiment and can minimize the overlapped area between the gap electrode units, such that it can form much lower capacitance than the first embodiment and its modified embodiments, which can inevitably generate the overlapped area.

The surge absorber of the eighth embodiment can sufficiently be applied in the array type. It can be considered that the surge absorber applied in the array form belongs to the scope of the present invention.

The present invention is not limited to the foregoing embodiments, but all changes and modifications that fall within metes and bounds of the claims, or equivalents of such metes and bounds are therefore intended to be embraced by the claims.

For example, it can be considered that the module having the composite elements, such as varistor or inductor, etc by using the surge absorber according to the foregoing embodiments falls within the scope of the present invention.

1. A surge absorber with a side gap electrode including:
an element on which a plurality of sheets are stacked;
a first electrode pattern having a first gap electrode unit that is formed on the sheet inside the element and is exposed to the outside of the element; and
a second electrode pattern having a second gap electrode unit that is formed on the sheet inside the element and is exposed to the outside of the element,
wherein the first and second gap electrode units forming a gap to a thickness of the sheet interposed therebetween.

2. The surge absorber with a side gap electrode according to claim 1, further including a first external terminal and a second external terminal formed on the element
wherein the first electrode pattern further includes a first internal electrode unit connected to the first external terminal and the second electrode pattern further includes a second internal electrode unit connected to the second external terminal.

3. The surge absorber with a side gap electrode according to claim 1, wherein the first electrode unit and the second electrode unit are exposed to the same side surface of the electrode.

4. The surge absorber with a side gap electrode according to claim 1, wherein the exposed first gap electrode unit and the second gap electrode unit are covered by the discharge medium.

5. The surge absorber with a side gap electrode according to claim 1, wherein a concave part is formed at the side surface of the element and the first and second gap electrode units are exposed through the concave part.

6. The surge absorber with a side gap electrode according to claim 5, wherein the discharge medium is filled in the concave part.

7. The surge absorber with a side gap electrode according to claim 6, wherein an outer surface of the filled discharge medium does not project from the side surface of the element.

8. The surge absorber with a side gap electrode according to claim 1, wherein the element is formed with holes and the first and second gap electrode units are exposed to an inner side surface of the hole.

9. The surge absorber with a side gap electrode according to claim 8, wherein the hole is formed to be penetrated through the element.

10. The surge absorber with a side gap electrode according to claim 1, wherein the first electrode pattern further includes a third gap electrode unit that is branched from a part of the corresponding electrode pattern and is exposed to the outside of the element and the second electrode pattern further includes a fourth gap electrode unit that is branched from a part of the corresponding electrode pattern and is exposed to the outside of the element,
the third gap electrode unit and the fourth gap electrode unit forming a gap to a thickness of the sheet interposed therebetween.

11. The surge absorber with a side gap electrode according to claim 10, wherein the first gap electrode unit and the second gap electrode unit are exposed to a first side surface of the element and the third gap electrode unit and the fourth gap electrode unit are exposed to a second side surface of the element.

12. The surge absorber with a side gap electrode according to claim 10, wherein the exposed first gap electrode unit and the exposed second gap electrode unit are covered by the discharge medium and the exposed third gap electrode and the exposed fourth gap electrode are covered by the discharge medium.

13. The surge absorber with a side gap electrode according to claim 6, wherein each of the first and second sides of the element is formed with the concave parts and the first gap electrode unit and the second gap electrode unit are exposed through the concave parts of the first side and the third gap electrode unit and the fourth gap electrode are exposed through the concave part of the second side.

14. The surge absorber with a side gap electrode according to claim 13, wherein each concave part is filled with the discharge medium.

15. The surge absorber with a side gap electrode according to claim 1, wherein the first electrode pattern and the second electrode pattern each is formed in plural and the first gap electrode unit in each first electrode pattern and the second gap electrode unit in each second electrode pattern forms the gap to the thickness of the sheet interposed therebetween.

16. The surge absorber with a side gap electrode according to claim 15, further including a plurality of first external terminals formed one surface of the element and a plurality of second external terminals formed on the other surface of the element
each of the plurality of first electrode patterns including the first internal electrode units connected to the plurality of first external terminals and each of the plurality of second electrode patterns including the second internal electrode units connected to the plurality of second external terminals.

17. The surge absorber with a side gap electrode according to claim 16, wherein the plurality of first gap electrode units and the plurality of second gap electrode units are exposed to a surface on which the plurality of first external terminals and the plurality of second external terminals are not formed.

18. The surge absorber with a side gap electrode according to claim 1, wherein the holes are formed in the element,
the first gap electrode unit is exposed to an inner side surface of the hole and
the second gap electrode unit is disposed on a bottom surface of the hole.

19. A surge absorber with a side gap electrode including:
an element on which a plurality of sheets are stacked;
a first input external terminal formed in the element;
a first output external terminal formed in the element;
a ground external terminal formed in the element;
a first internal electrode pattern having a first gap electrode unit that is formed on the sheet inside the element and is connected to the first input external terminal and the first output external terminal but is exposed to the outside of the element; and
an internal ground pattern having a first ground gap electrode unit that is formed on the sheet inside the element and is connected to a ground external terminal but is exposed to the outside of the element,
wherein the first gap electrode unit and the first gap electrode unit forming a gap to a thickness of the sheet interposed therebetween.

20. The surge absorber with a side gap electrode according to claim 19, further including:
a second input external terminal formed in the element;
a second output external terminal formed in the element; and
a second internal electrode pattern that is formed to be spaced from the first gap electrode unit on the sheet inside the element and is connected to the second input external terminal and the second output external terminal but includes the second gap electrode unit exposed to the outside of the element,
the internal ground pattern further including a second ground gap electrode unit exposed to the outside of the element and
the second gap electrode unit and the second ground gap electrode forming the gap to the thickness of the sheet interposed therebetween.

21. The surge absorber with a side gap electrode according to claim 20, wherein the first input external terminal and the second input external terminal are formed on a first side surface of the element and the first output external terminal and the second output external terminal are formed on a second side surface of the element.

22. The surge absorber with a side gap electrode according to claim 21, wherein the ground external terminal is formed on one side and both sides between the first input terminal and the second input external terminal and between the first output external terminal and the second output external terminal.

23. The surge absorber with a side gap electrode according to claim 21, wherein the ground external terminal is formed at a side different from the first side and the second side.

24. A method of manufacturing a surge absorber with a side gap electrode including:
forming a first electrode pattern that forms a first electrode pattern on a first sheet having a plurality of unit device regions;
forming a second electrode pattern that forms a second electrode pattern on a second sheet having a plurality of unit device regions;
forming a stacking body that stacks a plurality of sheets including the first sheet and the second sheet but overlappedly stacks a part of the first electrode pattern and a part of the second electrode pattern;
forming a plurality of holes at a portion where a part of the first electrode pattern and a part of the second electrode pattern are overlapped with each other so that a part of the first electrode pattern and a part of the second electrode pattern are exposed to an inner side surface of the holes and forms a gap to a thickness of the sheet interposed therebetween; and
forming a plurality of unit elements by cutting the stacking body for each unit element region so that each of the plurality of holes is separated by the cutting.

25. The method according to claim 24, further including filling the plurality of holes formed by the forming the holes with the discharge medium before the cutting.

26. The method according to claim 24, further including filling a part of each of the plurality of separated holes with the discharge medium after the cutting.
